(19) United States
(12) Patent Application Publication
(10) Pub. No.: US 2026/0332999 A1
(43) Pub. Date: Oct. 22, 2026

(54) XR SENSOR DATA QUANTIZATION, WAKE UP SIGNALING AND SYSTEM INFORMATION ENHANCEMENTS IN CELLULAR NETWORKS

(71) Applicant: Oswego Technologies LLC, columbus, NJ (US)

(72) Inventor: Ali Esswie, Calgary (CA)

(21) Appl. No.: 19/533,226

(22) Filed: Feb. 8, 2026

Related U.S. Application Data
(60) Provisional application No. 63/792,795, filed on Apr. 22, 2025.
(60) Provisional application No. 63/892,274, filed on Oct. 2, 2025.
(60) Provisional application No. 63/897,983, filed on Oct. 13, 2025.

(51) Int. Cl. H04W 4/38; H04L 5/14; H04W 52/02; H04W 72/21; H04W 72/231

(52) U.S. Cl. CPC H04W 4/38; H04L 5/1469; H04W 52/0235; H04W 72/21; H04W 72/231

(57) ABSTRACT

A method performed by a Radio Access Network (RAN) node for managing Extended Reality (XR) sensor data transmission may comprise establishing an XR session with a UE and determining an active XR application class associated with the UE; transmitting one or more of the sensor data dictionaries to the UE; and receiving, from the UE, uplink control information (UCI) comprising a selected dictionary identifier and a pattern row index corresponding to quantized sensor data.

### CROSS REFERENCE TO RELATED APPLICATIONS

This application claims benefit of U.S. Provisional Patent Application No. 63/792,795 filed on Apr. 22, 2025, U.S. Provisional Patent Application No. 63/892,274 filed on Oct. 2, 2025 and U.S. Provisional Patent Application No. 63/897,983 filed on Oct. 13, 2025, the contents of each of which is incorporated herein by way of reference entirely.

### BACKGROUND

US Patent Publication no. 2023/0337269 to Rao et al. titled “Methods, Architectures, Apparatuses and Systems for Extended Reality-Assisted Radio Resource Management” is incorporated herein by reference in its entirety. Rao discusses methods and systems for utilizing XR-assisted techniques to enhance radio resource management. Rao focuses on proactive cell selection and beam management by employing visual sensing to anticipate and prevent link failures in dense urban or indoor environments. Rao is silent to the use of sensor data dictionaries for quantizing and transmitting XR sensor data between the RAN and WTRU.

US Patent Publication no. 2023/0076644 to Murray et al. titled “Method and a Wireless Device for Collecting Sensor Data from a Remote Device Having a Limited Range Wireless Communication Capability” is reproduced herein by reference in its entirety. Murray describes methods for a wireless device to collect sensor data from remote devices with limited-range wireless communication capabilities. Murray focuses on efficient data collection from such devices and concentrates on collecting sensor data from remote devices with limited communication range. Murray is silent to managing XR sensor data transmission between a RAN node and a WTRU, respective quantization and proposed precision adaptation.

US Patent Publication no. 2025/0126511 to Starsinic et al. titled “Methods and Apparatuses for Associating Single-Modal Flows for Synchronization and Resource Allocation” is incorporated herein by reference in its entirety. Starsinic discloses an inter-traffic flow technique for multi-modal traffic.

US Patent Publication No. 2024/0114454 to Chien-Chun Cheng et al., reproduced herein by way of reference in its entirety, describes designs for a low-power wake-up signal (LP-WUS) and corresponding UE/network behavior. Cheng provides methods to generate LP-WUS waveforms (for example via time-domain OOK→frequency transform), how the UE receives an LP-WUS based on a configuration from the network, and how the UE decides whether to wake based on received LP-WUS energy or correlation metrics. Cheng focuses on waveform/sequence design and basic UE decision logic for waking from a low-power state.

US Patent Publication No. 20230239038 to Yan et al., reproduced herein by way of reference in its entirety, describes techniques to optimize NPDCCH/PDCCH monitoring for NB-IoT in NTN environments—e.g., limiting UE monitoring windows, adapting monitoring periodicity to NTN timing/propagation constraints, and changes to control-channel procedures to reduce UE energy consumption while ensuring control reception in fragmented DL opportunities. It focuses on efficient control-channel monitoring and may include alternate monitoring patterns tuned for NTN.

Yan focuses on control-channel monitoring optimization and fails to disclose a compact SI-postponement descriptor, SI continuity sequence identifiers, or a broadcast K-of-L SI-delivery contract with escalation actions targeted at coverage classes. Yan does not teach per-resource deferredTxAllowed flags and deferred-buffer HARQ tagging with defer-expiry timers for PUR/UL-SPS occasions falling in non-UL subframes. Yan does not disclose a broadcast guard descriptor with optional per-UE guard overrides for synchronized UEs as a coexistence mechanism with legacy TDD.

### SUMMARY

A method performed by a Radio Access Network (RAN) node for managing Extended Reality (XR) sensor data transmission may comprise establishing an XR session with a UE and determining an active XR application class associated with the UE; transmitting one or more of the sensor data dictionaries to the UE; and receiving, from the UE, uplink control information (UCI) comprising a selected dictionary identifier and a pattern row index corresponding to quantized sensor data.

### BRIEF DESCRIPTION OF THE DRAWINGS

FIG. 1 illustrates the overall procedural steps of the RAN node building and adjusting precision-aware XR dictionaries and rampaging XR traffic;

FIG. 2 illustrates the multi-precision XR dictionary adaptation;

FIG. 3 illustrates the sequential RAN node actions;

FIG. 4 illustrates an exemplary timeline of multiple successive LP WUS monitoring occasions;

FIG. 5 illustrates an LP WUS signaling flow between RAN node and devices;

FIG. 6 illustrates RAN-UE capability signaling exchange for enabling dynamically deferred uplink;

FIG. 7 illustrates an overall signaling flow of the scheduling operation of the NB IoT TDD payload; and

FIG. 8 illustrates a RAN node that determines, for a repeating period comprising subframes and SBFD symbols with concurrent downlink and uplink subbands, a set of downlink-valid time-frequency tiles, identifies that nominal SI or control anchors fall into tiles that are downlink-invalid, and selects alternative downlink tiles within the SI delivery window that satisfy guard-distance and Doppler constraints.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications, and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity may be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server may be a component.

Further, the various embodiments may be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media may comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications may be made to this configuration without departing from the scope or spirit of the various embodiments.

Extended Reality (XR), encompassing Virtual Reality (VR), Augmented Reality (AR), and Mixed Reality (MR), is increasingly utilized across diverse applications, including immersive entertainment, remote collaboration, industrial training, and telemedicine. These applications demand exceptionally low latency and high-fidelity data exchange to ensure seamless and responsive user experiences. Unlike traditional mobile services, XR responsiveness is tightly coupled not only to radio interface performance but also to real-time interpretation of a wide variety of human inputs, such as eye gaze direction, hand gestures, head motion, and full-body mobility.

These non-radio sensor inputs are captured continuously and should be processed with minimal delay to maintain application interactivity and realism. For instance, gaze tracking in a VR environment should be reflected in the rendered scene within a few milliseconds to prevent visual discomfort or disorientation. Similarly, gesture-driven interactions in AR applications require precise and low-latency interpretation to maintain usability. Conventional radio access techniques are not optimized for the highly dynamic and fine-grained nature of XR sensor data. Frequent uplink signaling of high-resolution sensor streams can quickly overwhelm radio resources, particularly during periods of network congestion. Therefore, efficient methods for managing the transmission and processing of XR sensor data are essential to support these next-generation use cases.

The solution described herein is broadly applicable to any established cellular communication session where real-time non-radio feedback data should be transmitted efficiently over the radio interface. While the embodiments focus on XR use cases, the techniques for dictionary-based quantization, adaptive fidelity control, and congestion-aware signaling are equally relevant to a wide range of latency-sensitive and sensor-driven applications, including robotics, industrial automation, autonomous systems, and teleoperation scenarios. In such contexts, non-radio sensor inputs—such as actuator states, positional telemetry, visual tracking data, or haptic feedback—are captured at the device side and require timely and accurate transmission to a network-side processing entity. The proposed solution enables these sensor streams to be compactly encoded and adaptively managed using pre-negotiated pattern dictionaries, with efficient uplink signaling supported through integration into existing RRC and MAC procedures. As such, the solution operates transparently over a generic cellular session and enhances responsiveness, reliability, and scalability for real-time feedback applications beyond traditional XR.

A wireless transmit/receive unit (WTRU), e.g. a UE, may include a processor, a transceiver, a transmit/receive element, a speaker/microphone, a keypad, a display/touchpad, non-removable memory, removable memory, a power source, a global positioning system (GPS) chipset and/or other elements/peripherals, among others. The transmit/receive element may be configured to transmit signals to, or receive signals from, a base station (e.g., the base station) over an air interface.

A RAN node may also include a processor, a transceiver and a transmit/receive element. In one embodiment, a RAN node (for instance a base station, gNB, satellite or the like) establishes an XR session with a WTRU and determines the active XR application class based on signaling received either from a core network entity or directly from the WTRU. Using this information, the RAN node constructs one or more sensor data dictionaries associated with specific sensing input types, such as gaze or motion, each tagged with a ‘TYPE indication’ and an associated ‘precision level’. The RAN node transmits these dictionaries to the WTRU using RRC setup signaling that includes metadata identifying the dictionary structure. During the session, the WTRU captures real-time sensor data, classifies it by TYPE, calculates Euclidean distances to dictionary patterns, and transmits a selected pattern row index and dictionary ID to the RAN node via uplink control information (UCI) signaling. The RAN node re-maps the index to full sensor data and forwards the reconstructed data to an XR rendering server via the backhaul.

In another embodiment, the RAN node monitors uplink resource utilization and detects congestion when usage exceeds a predefined threshold over a rolling time window. Upon detecting such congestion, the RAN node transmits a sensing dictionary deactivation request via downlink control information (DCI) signaling to the WTRU, instructing it to exclude one or more dictionaries—prioritizing deactivation of those with higher precision levels—to reduce uplink signaling overhead. The deactivation request includes a timer value or bitmap field identifying the affected dictionaries. The WTRU, upon receiving this request, stops using the specified dictionaries for pattern matching and limits its quantization operations to the remaining active sets, preserving essential functionality while conserving resources.

In another embodiment, the RAN node constructs a hierarchical dictionary structure for each TYPE indication, comprising a coarse-precision first dictionary for basic patterns and a fine-precision second dictionary for detailed patterns, each with distinct quantization error thresholds. The RAN node embeds metadata describing the hierarchical structure, including tier sizes and error thresholds, in the RRC signaling to the WTRU. During the session, the WTRU sequentially processes sensor data through the hierarchy—first matching against the coarse dictionary and then, driven by an on-demand or direct RAN configuration, refining with the fine dictionary—before selecting a pattern and transmitting its index. Thus, the RAN node may instruct the WTRU to skip directly to the fine tier by signaling a tier-skipping command via DCI when congestion is low, optimizing responsiveness for high-fidelity applications.

In another embodiment, the WTRU maintains a dynamic quantization error threshold framework that adjusts the fidelity of sensor data reporting based on the XR application class. The WTRU maps application classes to signaling profiles such as low-overhead, high-fidelity, or general-purpose and selects corresponding error thresholds for quantization. These thresholds guide the selection of dictionary patterns to ensure acceptable accuracy with minimal signaling. The WTRU periodically reports the active threshold to the RAN node using a dedicated MAC Control Element. Additionally, when the WTRU detects low battery conditions or an active power saving mode, it overrides application-driven target error threshold and increases the it by a preset offset to reduce computational and transmission burden, trading off fidelity for energy efficiency.

In an embodiment, the RAN node segments large dictionary payloads that exceed size thresholds into multiple packet data units (PDUs), each tagged with sequence numbers and TYPE indications, enabling the WTRU to reconstruct the full dictionary using the packet duplication convergence protocol (PDCP) layer reassembly. During operation, if the RAN node receives an invalid pattern index from the WTRU, it validates the index against the dictionary and, if necessary, triggers a retransmission request using DCI signaling. Once congestion subsides and uplink utilization falls below a hysteresis threshold, the RAN node reactivates previously deactivated dictionaries by sending a reactivation command via either DCI or RRC reconfiguration, restoring full quantization support for high-fidelity operation.

Extended Reality (XR) use cases, encompassing virtual reality (VR), augmented reality (AR), and mixed reality (MR), demand continuous, low-latency interaction between user devices and networked rendering or compute resources. These interactions rely heavily on a diverse range of real-time sensor inputs beyond traditional radio metrics, including eye gaze direction, head orientation, hand gestures, finger movements, facial expressions, and even micro-level cues such as eye blinks or body pose transitions. The fidelity and responsiveness of XR experiences are critically dependent on accurate and timely reporting of these non-radio inputs, which influence rendering decisions, viewpoint updates, and gesture recognition pipelines in sub-100 ms intervals.

In existing wireless communication systems, radio access network (RAN) nodes are primarily designed to interpret and act upon radio-layer performance indicators such as signal strength, interference levels, and resource utilization. Current radio control solutions and quality-of-service frameworks are agnostic to the application-layer significance of non-radio human input streams in XR applications. As a result, real-time sensor data—central to XR interactivity—is transmitted in a best-effort manner, without prioritization or compression mechanisms that account for the input's semantic relevance, latency sensitivity, or precision requirements. This disconnect between application needs and radio handling leads to inefficient scheduling, suboptimal compression, and frequent overshoots in latency budgets, degrading the immersive quality of XR sessions.

Moreover, human-generated XR inputs are often high in frequency and fine in granularity, requiring continuous uplink signaling even when radio conditions are suboptimal. Traditional buffer-based scheduling and throughput-centric radio algorithms may delay or throttle such sensor streams without understanding their application-critical timing dependencies. For example, a delay in reporting eye gaze direction or hand gesture updates may cause visual mismatch or user disorientation in head-mounted displays. Without awareness of the XR application class or the type of sensed input, the RAN node cannot distinguish between mission-critical gesture updates and delay-tolerant background data, resulting in indiscriminate treatment and potential loss of perceptual coherence.

To meet the stringent demands of XR and similar real-time applications, there is a need to integrate the semantics of non-radio device inputs into the RAN node's decision-making processes. This includes enabling dictionary-based quantization of XR sensor data, class-based input prioritization, and congestion-aware control signaling to dynamically adjust the fidelity and transmission frequency of user inputs based on both application context and network conditions. In a preferred embodiment, a solution embeds sensing metadata into radio signaling protocols such as RRC and MAC layers, allowing the RAN node to treat non-radio XR inputs as first-class entities during scheduling, compression, and uplink control. This approach ensures responsive, accurate, and resource-efficient delivery of human input data over cellular interfaces in support of immersive XR experiences.

Therefore, a method is performed by a Radio Access Network (RAN) node for managing sensor data transmission during an Extended Reality (XR) session or any session characterized by a high density of non-radio input metrics. The method begins with the establishment of a session between the RAN node and a Wireless Transmit/Receive Unit (WTRU), wherein the RAN node determines the active application class associated with the WTRU. This application class may pertain to immersive XR use cases or real-time industrial feedback loops, and informs the RAN node about the expected sensitivity of the application to latency and data fidelity. The application class may be derived through explicit signaling from the WTRU during RRC connection setup or dynamically updated via control messages during the active session, enabling the RAN node to classify the expected sensing behavior and prepare appropriate uplink configurations.

The method further supports real-time feedback optimization across broader application domains, including telepresence robotics, autonomous vehicle coordination, and industrial automation workflows. In such scenarios, real-time sensor feedback may consist of mechanical joint telemetry, tool positioning, haptic input states, or environmental monitoring data. These inputs, while non-radio in nature, directly influence task-critical functions and require transmission over radio interfaces with minimized latency and compression overhead. By adapting XR-derived sensing frameworks, including dictionary-based quantization, application-aware precision scaling, and congestion-aware signaling control, the RAN node provides a unified solution to support the high-performance uplink demands of emerging non-radio-centric cellular applications.

Thus, the RAN node determines whether a WTRU is associated with one or more operational categories—including Extended Reality (XR), Internet of Things (IoT), and enhanced Mobile Broadband (eMBB)—by evaluating signaling received during session establishment, such as class indicators embedded in RRC messages, or by inferring the device type from traffic characteristics like packet size, periodicity, and latency sensitivity; based on this determination, the RAN node selects one or more sensor data dictionaries tailored to the WTRU's operational category or any combination thereof, thereby ensuring that the dictionary payloads and quantization parameters align with the device's expected data profiles and service requirements.

In an embodiment, when the WTRU is identified as an XR WTRU, the RAN node selects dictionaries containing preconfigured gaze vector entries, three-dimensional pose estimations, and gesture data patterns optimized for high-frequency, low-latency uplink transmission; when the WTRU is classified as an IoT WTRU, the RAN node selects dictionaries populated with environmental telemetry patterns, mechanical state vectors, and periodic sensor values designed to minimize energy consumption and support sparse reporting; and when the WTRU is characterized as an eMBB WTRU, the RAN node either disables dictionary-based quantization or selects dictionaries optimized for multimedia session feedback—such as playback controls or user-interaction metadata—to accommodate throughput-centric, delay-tolerant data streams.

In another embodiment, the RAN node refines a sensor data dictionary for a target WTRU by harvesting high-frequency pattern entries from one or more peer WTRUs that exhibit a matching application profile, wherein the RAN node continuously collects recent uplink pattern indices reported by donor WTRUs and merges these entries into the target dictionary to capture emergent usage trends.

The RAN node leverages a suite of cross-WTRU correlation metrics—such as the relative frequency of pattern occurrence across devices, the physical proximity of donor and target WTRUs within a cell or neighbor cell, the degree of trajectory congruence in motion-based inputs, and the alignment of reported application classes—to identify which externally sourced pattern candidates are most likely to benefit the target dictionary's coverage.

The aggregation process may incorporate a confidence threshold filter, wherein each candidate pattern drawn from a donor WTRU is assigned a reliability score derived from historical accuracy and reporting consistency of the donor, and only patterns whose scores exceed the predefined confidence threshold are integrated into the target dictionary, thereby preventing noise or outliers from degrading quantization fidelity.

Thus, RAN node's dynamic dictionary optimization framework operates across multiple XR application classes—such as immersive rendering, gesture-driven control, and low-latency streaming—by adapting dictionary contents in real time based on device-class-specific usage profiles, such that the dictionary automatically evolves to include patterns reflective of the most relevant sensor behaviors for each application class, ensuring that the target WTRU continuously benefits from the collective experience of similarly situated devices.

Accordingly, the RAN node determines one or more sensor data dictionaries by mapping each dictionary to a specific TYPE indication that corresponds to an XR application sensing input, wherein the TYPE indication categorizes inputs such as eye gaze vectors, hand motion trajectories, head orientation quaternions, or other sensor-derived signals; the RAN node generates each dictionary by selecting representative pattern entries that capture the statistical distribution of the corresponding input TYPE, and associates a precision level and quantization error threshold with each dictionary to guide the WTRU in encoding sensor data into compact indices for uplink transmission.

Further, the RAN node identifies the XR application class via explicit signaling from a core network entity—such as a User Plane Function (UPF) or Network Data Analytics Function (NWDAF)—or via an application layer class indication provided by the WTRU through uplink control information (UCI) or Radio Resource Control (RRC) signaling, thereby enabling the RAN node to tailor dictionary selection and uplink resource allocations based on whether the session is classified as immersive rendering, interactive gesture control, low-latency streaming, or other XR service profiles.

In another embodiment, determining the XR application class via the application layer class indication received from the WTRU comprises extracting the XR application class from an information element in a Radio Resource Control setup request message, wherein the WTRU populates the information element with metadata describing its active XR application—such as the application's type, version, or performance requirements—and the RAN node parses this metadata during RRC connection establishment to assign the appropriate service class.

In another embodiment, the application layer class indication received from the WTRU includes a dynamic parameter update conveyed via a Medium Access Control Element, wherein the WTRU issues the MAC CE to modify the previously indicated XR application class during the active session in response to changes in application state or user interaction mode—such as transitioning from immersive exploration to gesture-based selection—allowing the RAN node to adjust sensing dictionary precision, uplink scheduling priority, and quantization parameters in real time.

For time-variant applications, the RAN node may receive, from the WTRU, a dynamic parameter update encapsulated in a Medium Access Control Element, wherein the MAC CE carries a structured update field that conveys an updated XR application class indicator originating from the WTRU's application layer.

The structured update field of the MAC CE includes a class identifier that specifies the new XR application class, enabling the RAN node to distinguish between modes such as immersive rendering, interactive gesture control, and low-latency streaming; this class identifier is defined according to a predefined enumeration of application profiles and is encoded in a fixed-length field within the MAC CE.

The MAC CE further comprises a state transition code or indication that reflects the specific change in XR application state, selected from a set of predefined codes—such as transitioning from gesture mode to gaze-driven rendering or entering a high-fidelity tracking state—thereby providing the RAN node with granular visibility into the WTRU's interaction context and performance requirements.

Such structured update field may also carry a timestamp representing the exact time at which the WTRU detected the application state change, and upon receipt, the RAN node validates this timestamp by confirming that it falls within a session synchronization window defined during RRC setup; validation ensures that only timely and synchronized class updates are acted upon, preventing stale or misaligned state changes from disrupting uplink resource allocation or dictionary configuration.

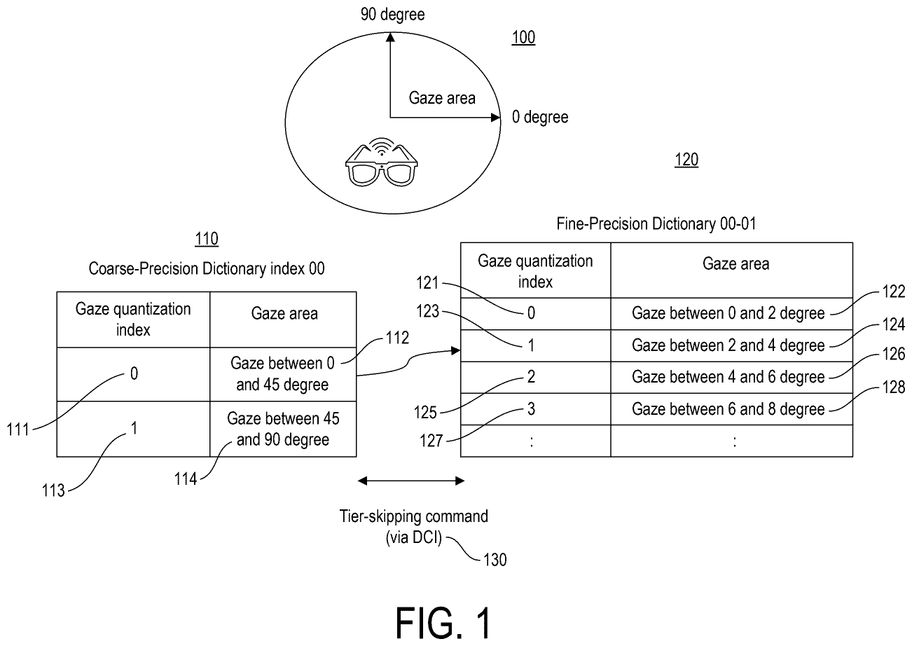

FIG. 1 illustrates the overall procedural steps of the RAN node building and adjusting precision-aware XR dictionaries and rampaging XR traffic. As shown in the example, the RAN node maintains a hierarchical network policy framework that defines precision levels for sensor data dictionaries according to a structured rule set, wherein each rule associates a given XR application class with a prioritized list of allowable precision levels.

In an example shown by FIG. 1, a gaze area 100 may be associated with a quantization index. For instance, a coarse prevision dictionary 110 may be used to provide a coarse quantization index of 0 111 for a gaze between 0 and 45 degrees 112 and a coarse quantization index of 1 113 for a gaze between 49 and 90 degrees 114. When gaze area is between 0 and 45 degrees 112, a fine prevision dictionary 120 may be used to provide a gaze quantization index of 0 121 for a gaze of between 0 and 2 degrees 122, a gaze quantization index of 1 123 for a gaze between 2 and 4 degrees 124, a gaze quantization index of 2 125 for a gaze between 4 and 6 degrees 126 and a gaze quantization index of 3 127 for a gaze between 6 and 8 degrees 128 and so forth.

In an embodiment, each precision level specified in the policy framework is characterized by a quantization error threshold and a corresponding dictionary payload size, such that finer precision levels entail lower error thresholds and larger payloads, while coarser levels permit higher error tolerances and smaller dictionary sizes.

RAN node evaluates the active XR application class-such as immersive rendering, interactive gesture control, or low-latency streaming- and references the policy framework to retrieve the ordered list of precision levels associated with that class, thereby preparing a set of candidate dictionary configurations that balance fidelity requirements against overhead constraints.

The RAN node measures current network load as a percentage of uplink resource block utilization and selects an initial precision level from the class-specific prioritized list by mapping lower utilization to higher-fidelity levels and higher utilization to coarser-fidelity levels, ensuring that the selected dictionary precision safeguards application responsiveness while respecting prevailing radio resource availability.

The RAN node constructs each sensor data dictionary by analyzing the frequency of sensor pattern indices reported by a plurality of WTRUs over a sliding aggregation window and selecting only those patterns whose occurrence counts exceed a predefined frequency threshold, thereby ensuring that the dictionary comprises the most common and representative input behaviors shared across devices in the XR session and minimizing overhead by excluding infrequent or outlier patterns.

Each TYPE indication is supported by a hierarchical, multi-tier dictionary framework in which a coarse-precision first tier contains a limited set of broadly representative sensor patterns with quantization error thresholds above a first predefined value and a fine-precision second tier contains a comprehensive set of detailed patterns with error thresholds below a second predefined value; the RAN node embeds metadata specifying the number of patterns per tier and the associated error thresholds in the RRC setup message to the WTRU, and when uplink resource usage falls below a predetermined congestion threshold, the RAN node issues a tier-skipping command 130 via DCI signaling—valid for a specified duration—to instruct the WTRU to bypass the coarse tier and begin pattern selection at the fine tier for enhanced accuracy.

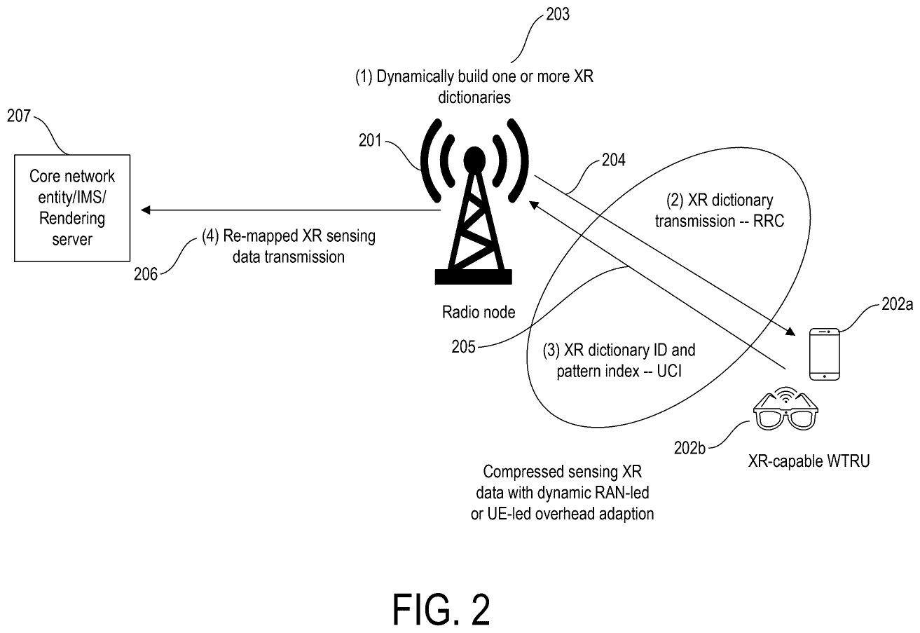

FIG. 2 illustrates multi-precision XR dictionary adaptation. As depicted by FIG. 2, the RAN node 201 may dynamically build 203 one or more XR dictionaries and deliver 204 the constructed sensor data dictionaries to the WTRU 202a, 202b by embedding dictionary metadata directly into the RRC setup signaling 204 exchanged during session establishment, where each dictionary is identified by a unique identifier, a TYPE indication corresponding to a specific sensor input category, and an associated precision level defining the quantization error threshold and payload size. This metadata is carried in dedicated information elements within the RRC Connection Setup or RRC Reconfiguration messages, enabling the WTRU to parse the number of available dictionaries, their TYPE classifications (such as gaze, hand motion, or mobility), and the initial precision levels without requiring additional signaling flows. By leveraging existing RRC protocol structures to convey dictionary definitions and parameter settings, the RAN node ensures that the WTRU is provisioned with all necessary pattern sets and fidelity constraints before any real-time sensor reporting begins, minimizing signaling latency and overhead.

Upon receipt of the dictionaries, the WTRU quantizes its live sensor measurements by matching each measurement to the closest pattern entry within the specified dictionary and then reports 205 its selection to the RAN node via uplink control information comprising the selected dictionary identifier and the pattern row index of the chosen entry. This UCI message 205 is transmitted over the Physical Uplink Control Channel or embedded within a MAC control element on the PUSCH, potentially carrying only the minimal payload of the dictionary ID and pattern index. When the RAN node receives this UCI, it uses the dictionary identifier to select the correct pattern set, retrieves the full sensor data corresponding to the reported row index, validates the index against the dictionary's range, and reconstructs the original sensor measurement for forwarding 206 to downstream entities such as an XR rendering server or core network analytics function 207.

When a constructed sensor data dictionary exceeds a predefined size threshold, the RAN node divides the dictionary payload into a series of protocol data units (PDUs) aligned with the scheduled uplink transmission grants, each PDU carrying a fragment of the dictionary and conforming to the radio frame timing and resource block assignments specified for the session.

Each PDU is tagged with a unique sequence number and the associated TYPE indication in its header, ensuring that the WTRU may unambiguously identify the dictionary to which each fragment belongs as well as the correct ordering of the fragments during reassembly; the sequence number allows the WTRU to detect missing or out-of-order PDUs and request retransmission if necessary.

Upon receiving the sequence of PDUs, the WTRU passes them through the Packet Data Convergence Protocol (PDCP) layer, which uses the sequence numbers and TYPE indications to reconstruct the complete dictionary payload by concatenating the fragments in the proper order, validating the integrity of the reassembled payload, and presenting the restored dictionary to higher-layer processing for sensor quantization.

As also illustrated by FIG. 2, the RAN node receives uplink control information 205 from the WTRU that includes a selected dictionary identifier and a pattern row index, and uses the identified dictionary to perform a table lookup that maps the pattern index to the corresponding full sensor data vector; after validating that the index falls within the permissible range and reconstructing the original sensor measurement—such as three-dimensional head orientation, gaze coordinates, or hand trajectory—the RAN node forwards the re-mapped data over the backhaul interface to an XR rendering server or other core network entity, ensuring that the contextualized sensor inputs are delivered with minimal latency for real-time rendering or analytics.

The RAN node continuously measures uplink resource utilization by tracking the percentage of allocated resource blocks or scheduling grants consumed over a rolling time window, and upon detecting that utilization exceeds a predefined congestion threshold, the RAN node generates a sensing dictionary deactivation request that specifies which dictionaries—typically those with the highest precision and largest signaling overhead—are to be temporarily disabled; this request is conveyed to the WTRU via Downlink Control Information signaling on the physical downlink control channel, enabling the WTRU to immediately adjust its quantization operations and reduce uplink traffic until resource availability improves.

Re-mapping the pattern row index to full sensor data further includes validating the received index against the associated dictionary's predefined pattern range and, upon detection of an out-of-range or otherwise invalid index, generating a retransmission request that is signaled to the WTRU via Downlink Control Information; this request identifies the specific dictionary ID and index in error, prompting the WTRU to resend the correct pattern index and thereby ensuring integrity of the quantized sensor reporting process.

The sensing dictionary deactivation request specifies a prioritized subset of dictionaries for temporary suspension based on their precision levels, with higher-precision dictionaries—those associated with larger payloads and greater uplink overhead—placed at the head of the deactivation list, while lower-precision dictionaries remain active to sustain baseline XR functionality and maintain continuity of essential user inputs under congested radio conditions.

Reactivation of previously deactivated sensing dictionaries occurs after the uplink resource utilization falls below a defined hysteresis threshold for a predetermined duration, at which point the RAN node issues a reactivation command through either Downlink Control Information signaling or an RRC reconfiguration message to restore full quantization capability and elevate the fidelity of sensor data reporting to pre-deactivation levels.

The deactivation request further includes a timer value that defines the duration for which each specified dictionary remains inactive, upon expiration of which the WTRU automatically reinstates the deactivated dictionaries unless the RAN node transmits a subsequent extension command via DCI signaling to prolong the deactivation period in response to ongoing network conditions.

Receiving one or more sensor data dictionaries from a serving RAN node, each dictionary associated with a TYPE indication and comprising a plurality of preconfigured sensor data patterns, the WTRU captures real-time sensor data from one or more local XR application sensors and classifies each data segment into a corresponding TYPE indication based on application context, sensor source, or system configuration parameters that indicate the nature of the input, such as gaze, gesture, or positional tracking.

Upon classifying the captured sensor data into a TYPE indication, the WTRU searches the set of received dictionaries for those associated with the identified TYPE indication, filtering out unrelated dictionaries and selecting only the subset whose TYPE matches the classification result; this dictionary filtering enables efficient access to relevant quantization patterns and reduces computational overhead associated with pattern matching.

For each segment of real-time sensor data, the WTRU searches the selected dictionary or dictionaries to identify a matching preconfigured pattern and generates a pattern row index corresponding to the closest matching entry; if no exact match is found, the WTRU may apply a nearest-neighbor or similarity-based matching algorithm to select the best-fit index, thereby enabling quantized representation of complex sensor data inputs.

Thus, in one embodiment, the WTRU calculates a Euclidean distance between the captured real-time sensor data and each preconfigured pattern in the identified dictionaries, wherein each dimension of the sensor data vector corresponds to a spatial or temporal feature such as position, orientation, velocity, or gaze direction, and the distance computation is used to evaluate the similarity between the observed sensor data and each dictionary pattern entry.

$$D ( s , d ) = \sqrt{{\sum }_{i = 1}^{n} {( {s}_{i} - {d}_{i} )}^{2}}$$

S=[s1, s2, . . . , sn]: Captured sensor data vector
D=[d1, d2, . . . , dn]: Dictionary pattern entry
n: Number of dimensions (e.g., position x, y, z; orientation quaternions)

The WTRU may further apply a weighted Euclidean distance calculation, wherein each dimension of the sensor data vector is assigned a weight based on the relative importance of the feature for the active XR application, such that critical features like eye gaze or hand pose are prioritized over secondary motion parameters during pattern selection.

$${D}_{w} ( s , d ) = \sqrt{{\sum }_{i = 1}^{n} {{w}_{i} ( {s}_{i} - {d}_{i} )}^{2}}$$

wᵢ∈[0,1]: Application-specific weights for feature i
Example: w_{gaze}>w_{velocity} for eye-tracking applications

The WTRU may compute a normalized Euclidean distance, wherein both the captured sensor data and each dictionary pattern are normalized using min-max scaling or z-score normalization prior to distance calculation, to ensure consistent pattern matching performance across heterogeneous XR sensor modalities with different value ranges or noise distributions.

$${D}_{norm} ( s , d ) = \sqrt{{\sum }_{i = 1}^{n} {( \frac{{s}_{i} - {μ}_{i}}{{σ}_{i}} - \frac{{d}_{i} - {μ}_{i}}{{σ}_{i}} )}^{2}}$$

μᵢ: Mean value of feature i in training data
σᵢ: Standard deviation of feature i

The WTRU may utilize a piecewise Euclidean distance metric that computes separate distances for individual sensor categories such as gaze, gesture, and body pose, and then aggregates the results using an application-specific fusion function, allowing the matching algorithm to maintain modular sensitivity across multimodal XR inputs.

$${D}_{m u l t i} ( s , d ) = {\sum }_{k = 1}^{K} {α}_{k} \sqrt{{\sum }_{j ∈ {G}_{k}} {( {s}_{j} - {d}_{j} )}^{2}}$$

Gₖ: Subset of dimensions for sensor group k (e.g., G₁=gaze, G₂=hand joints)
αₖ: Application or RAN received fusion weights.

Based on the computed Euclidean distances, the WTRU selects the pattern from the identified dictionary that yields the minimum distance to the captured sensor data, ensuring that the most representative quantized pattern is chosen for efficient transmission; the selected pattern is evaluated against a predefined quantization error threshold, which is configured based on the active XR application's tolerance for fidelity loss and responsiveness requirements.

The WTRU transmits the selected pattern's index to the RAN node only if the minimized Euclidean distance is below the quantization error threshold, thereby reducing uplink signaling of low-value or non-representative data and preserving radio resources; if the distance exceeds the threshold, the WTRU may either defer transmission, request a dictionary refinement, or transmit raw sensor data, depending on the application class policy or network instructions.

The quantization error threshold used by the WTRU to determine whether to transmit a selected pattern or raw sensor data is dynamically adjusted based on the currently active XR application class, utilizing a threshold adjustment framework stored locally at the WTRU. The framework includes a classification table that maps specific XR application classes to corresponding signaling categories, wherein applications classified as low-overhead are assigned a high quantization error threshold to reduce the frequency of uplink transmissions, applications categorized as high-overhead and fidelity-critical are assigned a low quantization error threshold to ensure high-accuracy sensor data reproduction, and general-purpose XR applications are assigned a medium threshold to balance signaling efficiency and sensor fidelity. The WTRU periodically transmits its currently applied quantization error threshold to the RAN node via a dedicated Medium Access Control (MAC) Control Element (CE) to support network-side coordination and adaptation.

The quantization error threshold may be further predefined per TYPE indication such that each class of sensor data input has a dedicated fidelity requirement. For instance, TYPE indications related to gaze direction are mapped to stricter quantization thresholds than those associated with body or user mobility patterns. This TYPE-specific threshold mapping enables the WTRU to selectively prioritize precision for data inputs that are visually or interactively critical to the XR user experience while relaxing constraints for lower-sensitivity data categories.

The WTRU further adjusts the quantization error threshold based on energy constraints, wherein the minimum allowable quantization error threshold may be overridden and incremented by a fixed offset if the WTRU's battery level falls below a predefined energy reserve threshold. This behavior enables the WTRU to conserve energy by tolerating increased quantization distortion, thereby reducing uplink reporting frequency and maintaining longer operational lifetimes under constrained power conditions.

If the WTRU fails to identify any pattern in the selected dictionary whose quantization error, calculated as the Euclidean distance between the captured sensor data and the pattern, falls below the current threshold, the WTRU switches to a fallback procedure by transmitting the full raw sensor data corresponding to the TYPE indication. This raw data is transmitted via uplink resources pre-allocated or dynamically scheduled by the RAN node to enable emergency fidelity recovery for application-critical inputs that cannot be adequately represented through quantization.

The sensor data dictionaries provided to the WTRU for a given TYPE indication are structured as a multi-tier hierarchy comprising at least a coarse-precision dictionary and a fine-precision dictionary. The WTRU initially processes the coarse-precision dictionary by computing Euclidean distances between captured sensor data and each coarse pattern, identifying a subset of candidate patterns. This subset is then refined by performing distance calculations against the patterns in the fine-precision dictionary, selecting the final pattern whose distance is the lowest and falls below the application-defined quantization error threshold. This two-stage approach enables scalable dictionary processing that reduces complexity while preserving high-accuracy selection in fidelity-critical XR application states.

Finally, the WTRU may receive a sensing dictionary deactivation request from the serving RAN node via Downlink Control Information (DCI) signaling, wherein the request identifies one or more dictionaries that are to be excluded from active use. Upon receiving the request, the WTRU suspends all sensor data classification and Euclidean distance calculations associated with the specified dictionaries for the duration of the deactivation period, thereby reducing uplink signaling load and supporting congestion mitigation efforts initiated by the RAN node. The WTRU maintains the deactivation state locally and monitors for reactivation commands or expiration of the deactivation timer before resuming operations involving the deactivated dictionaries.

The sensing dictionary deactivation request transmitted in the DCI signaling includes a bitmap field in which each bit corresponds to a unique dictionary identifier previously communicated to the WTRU. A bit value of ‘1’ within this bitmap indicates that the dictionary associated with the corresponding index is to be deactivated, while a bit value of ‘0’ indicates that the dictionary remains active. This compact representation allows the WTRU to rapidly parse the DCI message and update its active dictionary table without incurring additional processing overhead or requiring further signaling exchanges for identifier resolution.

The deactivation request further supports spatial or temporal granularity parameters that refine the scope of dictionary exclusion. Specifically, the DCI signaling may include sensor-specific filtering instructions, such that dictionaries associated with particular sensor types—such as gaze, gesture, or motion—are deactivated independently of others. Additionally, a time interval may be specified to limit the deactivation to periods that align with anticipated or observed congestion patterns. The WTRU uses these parameters to selectively apply dictionary exclusion rules based on both the type of sensor input and the timing of the sensor data collection, thereby achieving fine-grained adaptation that preserves critical XR functionality while managing network load.

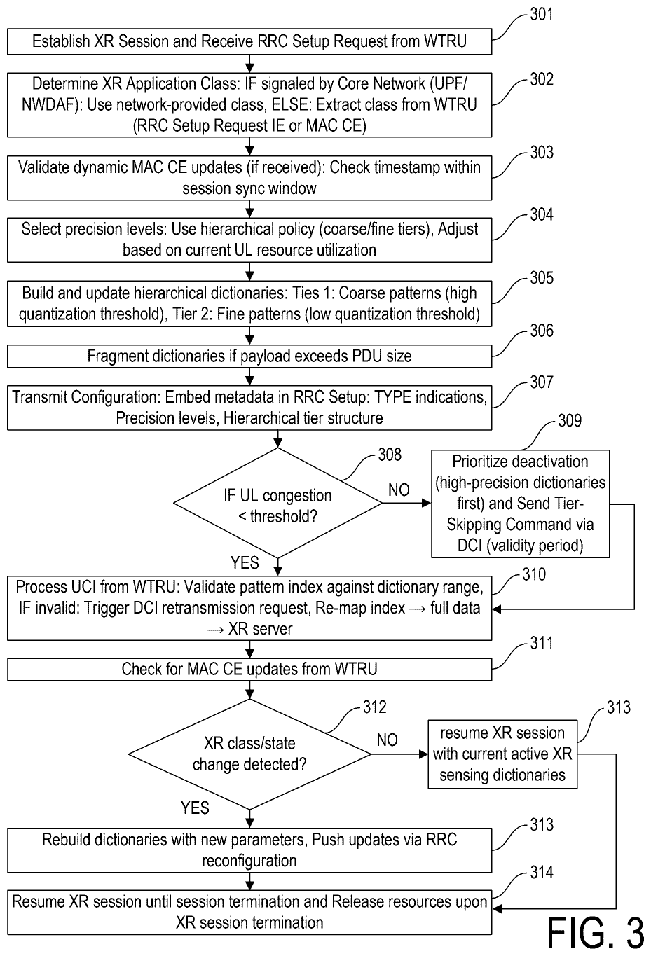

FIG. 3 illustrates sequential RAN node actions. FIG. 3 describes the overall RAN actions in terms of a process flow in which a Radio Access Network (RAN) node orchestrates adaptive sensor data management for XR services. The RAN node first receives a session establishment request 301 from a WTRU, including signaling that indicates the initiation of an XR session. The RAN node analyzes session-specific metadata or uplink signaling to identify the XR application class 302 associated with the WTRU, such as immersive rendering, interactive gesture control, or low-latency streaming. MAC CE updates are validated 303 and precision levels are selected 304. Based on the identified application class, the RAN node selects one or more sensor data dictionaries 305, each tagged with a TYPE indication and precision level, from a repository of predefined or dynamically generated dictionaries. The dictionaries are fragmented 306 if a payload size exceeds a PDU size and transmitted 307 to the WTRU via Radio Resource Control (RRC) setup signaling, including associated metadata such as dictionary identifiers, quantization thresholds, and tier information.

Following transmission, FIG. 3 shows the RAN node monitoring uplink control information (UCI) received from the WTRU, including selected dictionary identifiers and pattern row indices corresponding to quantized sensor data. The RAN node performs pattern remapping using the received indices and the original dictionaries to reconstruct full-resolution sensor data, which is then forwarded to an XR rendering server or a core network entity via a backhaul interface. The process further includes a congestion detection module within the RAN node, which continuously evaluates uplink resource block utilization over a rolling time window. When congestion exceeds a predefined threshold 308, the RAN node generates a sensing dictionary deactivation request 309, transmitted via Downlink Control Information (DCI) signaling, instructing the WTRU to exclude one or more dictionaries from active processing. If the UL congestion is below a threshold, the RAN node processes uplink control information 310 from the WTRU and checks for MAC CE updates 311.

FIG. 3 concludes with a feedback loop in which the RAN node reactivates previously deactivated dictionaries once uplink load drops below a hysteresis threshold, enabling restoration of full XR fidelity.

If a change in XR class/state 312 is not detected, an XR session is resumed 313 with current active XR sensing dictionaries. If a change in XR class/state 312 is detected, dictionaries are rebuilt with new parameters 313 and updates are pushed via RRC reconfiguration. An XR session may be resumed 314 until session termination. Resources are released upon XR session termination.

A method performed by a Radio Access Network (RAN) node for managing Extended Reality (XR) sensor data transmission, the method comprising: establishing an XR session with a Wireless Transmit/Receive Unit (WTRU) and determining an active XR application class associated with the WTRU; determining one or more sensor data dictionaries, each associated with a TYPE indication corresponding to an XR application sensing input; transmitting the constructed sensor data dictionaries to the WTRU, wherein dictionary metadata, including TYPE indications and precision levels, is embedded in RRC setup signaling; receiving, from the WTRU, uplink control information (UCI) comprising a selected dictionary identifier and a pattern row index corresponding to quantized sensor data; re-mapping the received pattern row index to full sensor data using the associated dictionary and transmitting the re-mapped data to an XR rendering server or a core network entity over backhaul interface; detecting uplink radio interface congestion based on resource utilization exceeding a predefined threshold over a rolling time window; and in response to detected congestion, transmitting a sensing dictionary deactivation request to the WTRU via Downlink Control Information (DCI) signaling.

The RAN node determines whether a WTRU is associated with one or more operational categories including Extended Reality (XR), Internet of Things (IoT), and enhanced Mobile Broadband (eMBB), based on signaling received during session establishment or inferred from traffic characteristics, and selects one or more sensor data dictionaries for the WTRU based on its operational category or combination thereof.

If the WTRU is determined to be an XR WTRU, the RAN node selects dictionaries comprising gaze vectors, pose estimations, or gesture data patterns, optimized for high-frequency, low-latency transmission; if the WTRU is determined to be an IoT WTRU, the RAN node selects dictionaries comprising environmental telemetry, mechanical states, or periodic sensor values optimized for energy efficiency and sparse reporting; and if the WTRU is an eMBB WTRU, the RAN node either disables dictionary-based sensing or selects dictionaries optimized for multimedia session feedback, such as playback controls or user-interaction metadata.

The RAN node constructs or refines a dictionary for a target WTRU by aggregating high-frequency sensor patterns observed from another WTRU with a similar application profile, wherein the cross-WTRU aggregation includes filtering of pattern candidates based on a threshold confidence level or historical reliability of the donor WTRU's reported data.

The XR application class is identified via explicit signaling from a core network entity, including a User Plane Function (UPF) or Network Data Analytics Function (NWDAF), or via an application layer class indication received from the WTRU through uplink control information (UCI) or Radio Resource Control (RRC) signaling.

Determining the XR application class via the application layer class indication received from the WTRU comprises extracting the XR application class from a Radio Resource Control (RRC) setup request message, wherein the RRC setup request includes an information element (IE) populated by the WTRU based on an active XR application's metadata.

The XR application class indication received from the WTRU includes a dynamic parameter update, wherein the WTRU modifies the indicated XR application class during the active session via a Medium Access Control (MAC) Control Element (CE) to reflect a change in XR application state or user interaction mode.

The RAN node receives, from the WTRU, a dynamic parameter update for the XR application class indication via a Medium Access Control (MAC) Control Element (CE), the MAC CE comprising a structured update field that includes: a class identifier specifying a new XR application class; a state transition code or indication indicating a specific change in XR application state, selected from a predefined set of states including immersive rendering, interactive gesture mode, or low-latency streaming; and a timestamp reflecting the time of the state change detection by the WTRU, wherein the RAN node validates the received MAC CE by: verifying that the timestamp falls within a predefined session synchronization window.

The precision levels of the sensor data dictionaries for a TYPE indication are predefined based on a hierarchical network policy framework maintained by the RAN node, the framework comprising: a set of rules mapping each XR application class to a prioritized list of precision levels, wherein each precision level is associated with a specific quantization error threshold and dictionary payload size; wherein the RAN node selects an initial precision level for each dictionary based on the identified XR application class and current network load, measured as a percentage of uplink resource block utilization.

The sensor data dictionary is constructed by selecting a number of sensing patterns with the highest frequency of occurrence across WTRU-reported sensor data, wherein each selected pattern exceeds a predefined frequency threshold, ensuring the dictionary represents common patterns shared by the plurality of WTRUs of the XR session.

The sensor data dictionaries for a TYPE indication are structured hierarchically in a multi-tier framework, comprising: a coarse-precision first dictionary, containing a limited set of broadly representative sensor data patterns with a quantization error threshold above a first predefined value, and a fine-precision second dictionary, containing a comprehensive set of highly detailed patterns with a quantization error threshold below the second predefined value, applied to finalize the selection for maximum accuracy; wherein the RAN node transmits the hierarchical dictionaries to the WTRU with metadata specifying the number of patterns per tier and the quantization error thresholds, embedded in a Radio Resource Control (RRC) setup message; and wherein, the RAN node signals a tier-skipping command via Downlink Control Information (DCI) signaling when network conditions indicate low uplink congestion below a preset threshold instructing the WTRU to bypass the first dictionary and start pattern selection at the second dictionary, with the command including a validity period to limit the duration of the tier-skipping behavior.

Delivering dictionary payloads exceeding the predefined size threshold comprises fragmenting the payload into multiple protocol data units (PDUs) for scheduled data transmission, wherein each PDU includes a sequence number and TYPE indication to enable the WTRU to reconstruct the full dictionary payload using a Packet Data Convergence Protocol (PDCP) layer reassembly procedure.

Re-mapping the pattern row index to full sensor data includes validating the received index against the associated dictionary's predefined pattern range, and upon detecting an invalid index, triggering a retransmission request to the WTRU via Downlink Control Information (DCI) signaling to correct quantization errors.

The sensing dictionary deactivation request specifies a subset of dictionaries to deactivate based on their precision levels, wherein higher-precision dictionaries associated with larger signaling overhead are prioritized for deactivation by placing them on top of the list of available dictionaries to deactivate, while lower-precision dictionaries remain active to sustain baseline XR functionality.

A method may comprise reactivating deactivated sensing dictionaries after the uplink resource utilization falls below a hysteresis threshold for a predefined duration, wherein the RAN node transmits a reactivation command via DCI signaling or RRC reconfiguration to restore full quantization capabilities.

The deactivation request includes a timer value defining the duration of dictionary deactivation, after which the WTRU automatically reactivates the dictionaries unless a subsequent extension command is received via DCI signaling.

A Wireless Transmit/Receive Unit (WTRU) for adaptive Extended Reality (XR) sensor data reporting may comprise: a receiver configured to receive, from a serving Radio Access Network (RAN) node, one or more sensor data dictionaries, each associated with a TYPE indication and including a plurality of preconfigured sensor data patterns; circuitry configured to capture and store real-time sensor data from one or more XR application sensors and classifying the data into a TYPE indication; circuitry configured to identify, from the received dictionaries, the one or more available dictionaries associated with the classified TYPE indication; circuitry configured to calculate an Euclidean distance between the captured sensor data and each preconfigured pattern in the identified dictionaries; circuitry configured to select a pattern from the identified dictionaries that minimizes the Euclidean distance, wherein the selected pattern is transmitted only if the minimized distance is below a quantization error threshold predefined by the XR application; a transmitter configured to transmit, to the RAN node via uplink control information (UCI) signaling, a dictionary identifier and pattern row index corresponding to the selected pattern; and the receiver further configured to receive, from the RAN node, a sensing dictionary deactivation request via Downlink Control Information (DCI) signaling, the request specifying one or more deactivated dictionaries; and during an active deactivation period, excluding sensor data classification and Euclidean distance calculations for the deactivated dictionaries.

The quantization error threshold is dynamically adjusted based on the active XR application class using a predefined threshold adjustment framework maintained by the WTRU, the framework comprising: a classification table mapping one or more XR application classes to one of signaling categories: Low-overhead assigned a first high quantization error threshold to prioritize low signaling overhead, reducing the frequency of uplink transmissions; High-overhead (Fidelity-critical applications) assigned a second low quantization error threshold to minimize quantization distortion, ensuring high sensor data accuracy; general-purpose XR assigned a third medium quantization error threshold to balance signaling overhead and data fidelity; wherein the WTRU periodically reports the current quantization error threshold to the RAN node via a dedicated Medium Access Control (MAC) Control Element (CE).

The quantization error threshold is predefined per TYPE indication, such that gaze patterns are assigned a stricter threshold than user mobility patterns to preserve visual accuracy in XR rendering.

The minimum allowable quantization error threshold is overridden and increased by the WTRU with a fixed preset increment when the WTRU battery level falls below a predefined threshold, prioritizing energy efficiency over quantization accuracy.

The WTRU may transmit raw sensor data instead of a pattern index if the minimized Euclidean distance exceeds the quantization error threshold, wherein the raw data is transmitted via scheduled uplink resources allocated by the RAN node for emergency fidelity recovery.

The sensor data dictionaries for a TYPE indication are structured hierarchically in a multi-tier framework, comprising: a coarse-precision first dictionary and a fine-precision second dictionary; wherein the WTRU processes the dictionaries sequentially by: calculating Euclidean distances between captured sensor data and patterns in the coarse-precision first dictionary to identify a first subset of candidate patterns; calculating Euclidean distances for the second subset against patterns in the fine-precision second dictionary to select the final pattern with the lowest distance, provided the distance is below a quantization error threshold predefined for the XR application.

The sensing dictionary deactivation request includes a bitmap field in the DCI signaling, wherein each bit corresponds to a specific dictionary identifier, and a bit value of ‘1’ indicates deactivation of the associated dictionary, enabling the WTRU to rapidly parse and apply the deactivation command without additional decoding.

The deactivation request includes spatial or temporal granularity parameters, instructing the WTRU to exclude dictionaries only for specific sensor types during designated time intervals, aligning with periodic congestion patterns observed by the RAN node.

A method and system for adaptive sensor data reporting in wireless communication networks supporting Extended Reality (XR) applications are disclosed. A Radio Access Network (RAN) node identifies an XR application class for a Wireless Transmit/Receive Unit (WTRU) and selects one or more sensor data dictionaries based on TYPE indications associated with sensing input categories. The dictionaries are transmitted to the WTRU via control signaling, enabling quantization of real-time sensor data using preconfigured pattern matching, including Euclidean distance calculations against dictionary entries. The RAN node reconstructs the original data from reported pattern indices and adapts dictionary use based on uplink congestion, issuing deactivation or tier-skipping commands accordingly. The WTRU dynamically adjusts quantization thresholds based on XR application type, device energy status, and network instructions. Hierarchical dictionary structures support varying levels of precision. The system reduces signaling overhead while preserving XR fidelity, enabling scalable, context-aware sensor data management for next-generation immersive wireless applications.

Wireless systems increasingly rely on low-power wake-up signaling (LP-WUS) and simplified receiver paths to extend user-equipment (UE) battery life while maintaining acceptable latency for sporadic downlink activity. In connected mode, a network may embed short LP-WUS transmissions across selected OFDM symbols and repeat them over multiple monitoring occasions (MOs) within a DRX cycle so that the UE can idle most circuitry yet remain reachable. However, in practice, UEs frequently cannot observe every symbol of a configured LP-WUS pattern due to factors such as measurement gaps, concurrent UL/DL activity, bandwidth-part (BWP) switches, slot-format constraints, or coexistence with other downlink signals.

Existing approaches (e.g. US20230239796 to Li, titled ‘Wake up signal processing method and apparatus’ (reproduced herein by reference in its entirety) commonly treat any partially missed wake slot as a lost opportunity, leading to missed wake events, added scheduling and retransmission overhead, higher effective latency, and erosion of the intended energy savings. These limitations are exacerbated in challenging deployments (e.g., satellite/NTN with large delay/Doppler, beam sweeping, or mixed slot types) where symbol availability can be further constrained. Accordingly, there is a need for mechanisms that permit reliable LP-WUS detection and authenticated wake decisions when only a subset of the configured LP-WUS symbols and/or only a subset of the configured MOs are observed, thereby preserving low latency and energy efficiency without requiring contiguous symbol visibility.

US20240397422 to Martin et al. is reproduced herein by reference in its entirety. Martin discloses a method implemented by a wireless transmit/receive unit (WTRU). The method may comprise receiving configuration information. The configuration information may comprise information regarding a first discontinuous reception (DRX) cycle with a first periodicity and a second DRX cycle with a second periodicity. The configuration information may comprise a time offset value (T). The configuration information may comprise a threshold value for wake-up signal (WUS) detection. The configuration information may comprise a number (N) of monitoring occasions for missed WUS detections. The method may comprise monitoring for a WUS according to the first periodicity. The method may comprise monitoring for a paging indication according to the second periodicity. The method may comprise monitoring, on a condition that a WUS is not detected, for the paging indication according to the first periodicity, and receiving the paging indication. The method may comprise transmitting data over a physical random access channel (PRACH).

Bluetooth Core Specification, Version: v6.0, Version Date: 2024 Aug. 27 is reproduced herein by reference in its entirety. Specifically, any/all Bluetooth messages may be modified to include, incorporate and/or indicate the signals and transmissions described herein.

US20250310873 to Pignataro et al. is reproduced herein by reference in its entirety. Pignataro discloses a first wireless device that is capable of wirelessly transmitting a wake-on-radio trigger (e.g., a special packet/frame containing a special control word, bit pattern or the like) based on wake-on-radio control logic configured for the wireless device in which the trigger can be used to cause another wireless device to which the first wireless device can or seeks to connect/associate to transition from a low-power state to a full-power state. Pignataro's wake-on-radio trigger may be amended accordingly as described herein.

In one exemplary embodiment, a WTRU/UE supports partial monitoring of configured LP-WUS symbols by dynamically cross-referencing its internal scheduling table with the LPWUSPatternConfig received from the network. When symbols overlap with any potential measurement gaps or scheduled or sudden (sporadic) uplink transmissions, the WTRU marks them unavailable, computes symbol-level correlation scores for the remaining observed symbols, and performs soft-combining across multiple upcoming monitoring occasions. If the fused score crosses the early-stop threshold, the device immediately ramps its main receiver to active mode and reports tentative detection.

Further, in a RAN node embodiment, it configures an LPWUSPatternConfig that explicitly identifies one or more OFDM symbol indices for carrying the WUS signals, redundancy coding parameters, and split-token authentication rules, while also defining symbol reservations aligned with any active sub-band full duplex (SBFD) slot-type restrictions. The RAN node signals this configuration to the WTRU and ensures multiplexing with PDSCH, CSI-RS, or SSB transmissions by applying standard puncturing budgets and quasi-orthogonal code separation. When multiple UEs share the same symbol region, each receives a distinct code index to maintain orthogonality, i.e., additional code multiplexing.

Moreover, a WTRU reconstructs authentication across split monitoring occasions by collecting partial tokens transmitted in different time slots. Upon receiving the final fragment, the WTRU verifies a lightweight, and/or predefined, integrity checksum and only transitions fully (i.e., activate the full power transceiver) into connected reception once both the detection threshold and token verification are satisfied. If early fragments already indicate a fast token, the WTRU may activate sooner and then validate upon completion.

Further, a RAN node may adapt the wake-up scheduling by analyzing uplink control reports containing per-MO detection confidence (or rate) and symbol availability metrics. Using these reports, the scheduler generates MAC-CE remap instructions that temporarily shift wake-up symbol positions to indices the WTRU is more likely to monitor, ensuring higher reliability and reducing the chance of wasted wake attempts.

In another embodiment, a WTRU employs adaptive thresholding by maintaining short-term statistics of false alarms and missed detections. When false alarms increase, the WTRU raises the threshold, and when missed detections rise, it lowers it by a preconfigured offset. This dynamic adjustment helps balance latency and energy savings. For example, if the fused detection score is below threshold but the missed-detection risk remains acceptable, the WTRU defers activation and continues combining across subsequent monitoring occasions.

In the uplink direction, the RAN node may additionally configure uplink-side wake signaling through new information elements such as ULPWUSPatternConfig and ULPartialSymbolWUSCap. A WTRU may then transmit a mini-PRACH token, an SRS-embedded wake signal, or a lightweight PUCCH ping when attempting to wake the gNB. The gNB processes partial-symbol UL receptions using combining logic similar to the downlink, ensuring robustness even if the WTRU can only send a subset of the configured uplink symbols due to duplex or power constraints.

Moreover, a sidelink device may leverage the same partial-symbol combining method by monitoring short wake-up signals positioned adjacent to PSCCH or PSBCH symbols. If sensing gaps prevent observation of all configured symbols, the device soft-combines what is observed across multiple sidelink discovery occasions and applies an early-stop rule to reduce latency. A split authentication token spanning multiple discovery periods prevents spoofing, and a confirmation message exchanged over sidelink ensures authenticity before both devices enter active communication.

A RAN node may also transmit service-specific collision policies instructing whether a UE should assume a missed monitoring occasion as “detected” or “not detected.” This policy is tailored per service type, for example, delay-sensitive services may assume detection to minimize missed opportunities, while energy-prioritized services may assume not detected. The WTRU encodes its applied policy in uplink feedback, and the RAN adjusts redundancy or confirmation signaling accordingly.

Finally, a WTRU may periodically transmit compact diagnostics including detection reliability, symbol usage profiles, and energy savings achieved. The RAN aggregates these diagnostics across UEs and tunes future scheduling, including assigning more redundancy to UEs with poor coverage, adjusting multiplexing to reduce puncturing overhead, and optimizing code-domain separation. This closed-loop process ensures wake-up latency, energy efficiency, and reliability targets are continuously met.

Further, in a WiFi deployment, an access point (AP) provisions a station (STA) with a wake-up pattern using reserved OFDM sub-symbols or short “target wake time” (TWT) service periods, where the wake-up beacons may be fragmented across multiple OFDM symbols within a beacon interval. The STA advertises a capability indicating partial-symbol wake detection, including a bitmap of unavailable sub-symbols during channel sounding or uplink OFDMA transmissions. The AP transmits wake-up sequences redundantly across multiple beacon intervals or TWT slots, and the STA performs soft combining of correlation metrics collected from the observed subset. If a minimum confidence threshold is exceeded, the STA activates its full receive chain, thereby achieving lower latency without breaking backward compatibility with legacy Wi-Fi wake-up radios.

In an additional Bluetooth embodiment, a Bluetooth LE central device transmits a wake-up preamble encoded over multiple advertising channels, each carrying a sub-token of an authentication value. A peripheral device equipped with a low-power wake-up receiver monitors only a subset of advertising events due to duty-cycling or overlapping transmissions. The peripheral soft-combines correlation energy across observed sub-tokens to reconstruct the authentication token. By aggregating across multiple advertising intervals, the peripheral can validate wake-up without requiring continuous monitoring.

In an embodiment, a UE may also be configured to monitor LP-WUS transmissions that may be sent concurrently or cooperatively from two or more base stations, including relay nodes. Each base station transmits a portion of the LP-WUS pattern, such that the UE can soft-combine symbol metrics across geographically diverse sources. The RAN may assign per-cell reliability weights so that symbols from a relay node (closer proximity, lower Doppler) contribute more heavily to the fused detection score, while symbols from a macro base station act as redundancy. This configuration ensures that even if the UE cannot observe all symbols from one node due to shadowing or interference, successful wake-up can still be achieved by combining across multiple base stations. The same method may apply to side-link relays, where peer devices forward partial wake-up sub-tokens to extend coverage in sparse deployments.

In embodiments, XR and other low latency required devices may employ wake up signal monitoring as described in embodiments herein. For instance, when a WTRU/UE detects low battery conditions or an active power saving mode, it overrides application-driven target error threshold and increase by a preset offset to reduce computational and transmission burden, trading off fidelity for energy efficiency. In a low power mode, a device may use a combination of the low power transceiver to save power and a high power transceiver to perform XR functionality.

In an embodiment, a method performed by a user equipment (UE) for detecting a low-power wake-up signal (LP-WUS) begins with the UE receiving, from a radio access network (RAN) node such as a gNB, configuration information that explicitly defines a set of OFDM symbol positions forming an LP-WUS pattern associated with at least one monitoring occasion within a configured discontinuous reception (DRX) cycle.

The configuration information is delivered, for example, via an RRC message and may include not only the indices of the OFDM symbols within one or more slots where the LP-WUS energy will be transmitted, but also associated parameters such as a redundancy coding scheme, inter-symbol parity mapping, and an ordered schedule of multiple monitoring occasions per cycle. The configuration may further comprise a per-monitoring-occasion weight table, symbol reservation rules aligned with SBFD slot types, and code-domain multiplexing identifiers if multiple UEs share a symbol region.

Upon reception of this information, the UE stores the symbol positions and related parameters in its memory and prepares its low-power receiver chain to monitor the identified subset of OFDM symbols rather than the entire slot, thereby significantly reducing energy consumption. The UE may additionally report a symbol-availability profile indicating which configured symbol indices are likely to be unavailable due to internal operations such as measurement gaps, bandwidth part (BWP) switching, or uplink transmission conflicts. This feedback enables the network to refine the symbol placement or issue a MAC control element remapping instruction to improve future observability.

The configuration may also define different symbol reservation strategies per slot type (e.g., full slot, mini-slot, or mixed slot) and multiplexing behavior when LP-WUS coexists with downlink data or reference signals. In this way, the initial step of receiving and processing LP-WUS configuration information allows the UE to align its partial-symbol monitoring behavior with the network's transmission plan, setting the foundation for reliable detection, soft-combining across multiple occasions, and authenticated wake-up decisions under practical operating constraints.

Such configuration information received by the user equipment (UE) further includes redundancy coding parameters associated with the LP-WUS pattern, enabling more robust detection when only a subset of the transmitted symbols is observed. These redundancy parameters may define, for example, a repetition factor indicating how many times each wake-up bit is transmitted across different symbol positions, an inter-symbol parity mapping specifying how parity bits are distributed among symbols, and an error detection checksum appended across multiple monitoring occasions.

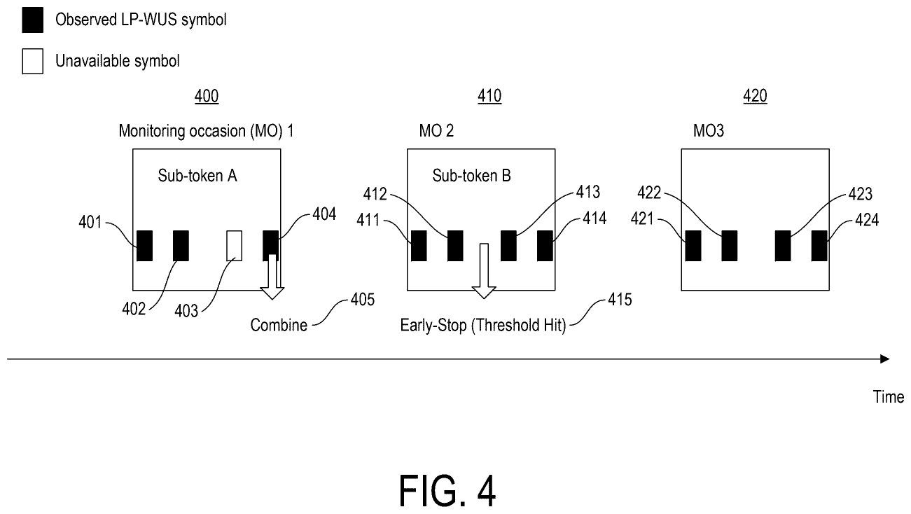

FIG. 4 illustrates an exemplary timeline of multiple successive LP WUS monitoring occasions. Upon reception of this information, the UE uses it to guide the soft-combining process when aggregating symbol-level detection metrics. Specifically, for each observed symbol, the UE computes a matched-filter correlation output or raw energy estimate and normalizes it by a locally estimated noise variance, producing a per-symbol score that reflects the likelihood of LP-WUS presence. These per-symbol scores are then combined across all observed symbols—and potentially across multiple monitoring occasions—using weighting factors derived from both the per-MO weight table and the redundancy structure.

Specification, in MO 1 400, the UE may observe a LP-WUS in a first symbol 401 and second symbol 402, a third symbol 403 may be unavailable and an LP-WUS may be observed in a fourth symbol 404. The UE may combine 405 a per symbol score across all observed symbols.

In MO 2 410, there may be a LP-WUS in a first symbol 411, second symbol 412, third symbol 413 and fourth symbol 414, but the UE may perform an early stop 415 after detecting the second LP-WUS due to a threshold being met.

In MO 3 420, a UE may observe LP-WUS in a first symbol 421, second symbol 422, third symbol 423 and fourth symbol 424, but may not make a decision during the monitoring occasion 420.

In one implementation, the fused detection score Sf is computed as

$${S}_{f} = \frac{{\sum }_{i = 1}^{N} {w}_{i} {m}_{i}}{{\sum }_{i = 1}^{N} {w}_{i}}$$

where mᵢ represents the normalized symbol-level detection metric (e.g., correlation value or SNR) for the observed symbol across one or more monitoring occasions, and wᵢ is the per-occasion or per-symbol reliability weight.

For example, repeated symbols may be assigned proportional weights to prevent double-counting, while parity-coded symbols may be weighted more heavily if they carry additional reliability information. The combined detection statistic can be computed as a weighted sum or a log-likelihood ratio (LLR), allowing the UE to infer LP-WUS presence even when only a subset of the coded pattern is available. Additionally, redundancy-aware combining enhances performance under practical impairments such as symbol blockage, partial reception, or Doppler distortion, as the redundancy structure inherently provides diversity gain. This redundancy-based soft-combining process enables the UE to maintain high detection probability and low false-alarm rates while minimizing energy consumption, thereby preserving the benefits of low-power wake-up signaling even under non-ideal monitoring conditions.

In another embodiment, the method further comprises receiving, from the radio access network (RAN) node, a per-monitoring-occasion weight table that assigns distinct reliability weights to different monitoring occasions based on network-side knowledge such as interference conditions, scheduling conflicts, channel quality, or symbol placement reliability. This weight table is signaled to the user equipment (UE) along with or subsequent to the LP-WUS pattern configuration, and each weight entry corresponds to a particular monitoring occasion within a configured discontinuous reception (DRX) periodicity.

Upon reception of the weight table, the UE incorporates the weights into the computation of the fused detection score by scaling each per-symbol detection metric-such as matched-filter correlation, normalized energy, or signal-to-noise ratio (SNR), by the weight associated with the monitoring occasion in which that symbol was observed. In one implementation, the UE first computes a normalized symbol-level score for each monitored symbol and then multiplies each score by the corresponding monitoring-occasion weight before summing the results across all observed symbols and occasions to produce a single fused detection statistic. This approach allows symbols observed during higher reliability monitoring windows, for example those with lower interference or better synchronization, to contribute more significantly to the detection decision than symbols from less reliable occasions.

Accordingly, in one exemplary embodiment, the RAN node signals not only the per-monitoring-occasion weight values but also an indicator specifying which symbol-level metric(s) the weight should scale. For example, the network may configure the UE to apply weights only to normalized correlation scores, to raw energy measurements, or to composite SNR estimates. This avoids ambiguity in the combining logic and ensures consistency across different UEs.

In another embodiment, the network/RAN node provides additional scaling instructions along with the weight table, such as a normalization constant, a noise variance estimate, or a maximum ratio combining flag. The UE incorporates these instructions to decide whether to normalize each symbol's detection metric prior to weighting, or whether to directly multiply raw values. Such signaling allows the RAN to align UE combining behavior with prevailing interference or Doppler conditions.

In a further embodiment, the RAN may signal a mapping between fused detection thresholds and weight usage. For instance, when high-confidence detection is desired (e.g., URLLC traffic), the network may instruct the UE to double the contribution of certain monitoring occasions, while for energy-saving operation (e.g., best-effort traffic) the UE may be instructed to halve the weight of lower-reliability symbols. This signaling can be conveyed via MAC control elements or through dedicated LP-WUS configuration fields.

In yet another embodiment, the network may signal a code-domain index or multiplexing profile that informs the UE whether to apply per-symbol weighting before or after code de-spreading in cases where multiple UEs share the same symbol region with orthogonal codes. This ensures that combining occurs in the correct processing domain, avoiding misalignment when code-division multiplexing is used for wake-up signaling.

The weighting mechanism may further support dynamic adaptation, as the RAN node may update the per-occasion weights based on real-time network measurements or UE-reported confidence telemetry. By incorporating these weights into the combining process, the UE improves detection reliability and robustness under non-ideal conditions, enabling earlier and more accurate wake-up decisions while maintaining the low-power operation of the wake-up receiver.

Thus, a subset of the plurality of OFDM symbol positions defined in the LP-WUS configuration are available to the user equipment (UE) based on its internal scheduling constraints, operational state, and radio activity. The UE maintains a symbol-availability profile that reflects which symbols can be observed during each monitoring occasion, taking into account factors such as measurement gaps, uplink transmission conflicts, half-duplex restrictions, or bandwidth part (BWP) switching events. During each configured monitoring occasion, the UE activates its low-power receiver chain only during the time intervals corresponding to the available symbols and samples the received signal within those symbol windows. For each monitored symbol, the UE generates a symbol-level detection metric indicative of the presence of LP-WUS energy or correlation with a known reference sequence.

This process may involve performing a matched-filter operation using the LP-WUS reference waveform, estimating received energy above a noise floor, or computing a signal-to-noise ratio (SNR) for the monitored symbol. In one implementation, the UE further normalizes the detection metric by a locally estimated noise variance to improve robustness against varying interference conditions. Each per-symbol detection metric represents the likelihood that the LP-WUS waveform is present on that symbol, and these metrics are subsequently used as inputs to a combining engine that fuses observations across multiple symbols and potentially across multiple monitoring occasions. By monitoring only a subset of the configured symbol positions, the UE significantly reduces receiver power consumption while maintaining the ability to reliably detect wake-up signals, even in cases where some symbols are blocked or unavailable, thereby improving both detection performance and energy efficiency under realistic operating conditions.

Thus, the symbol-level detection metrics computed for the monitored subset of OFDM symbols and, when available, incorporating metrics from at least one previous monitoring occasion to produce a fused detection score indicative of LP-WUS presence. The combining procedure may involve normalizing each per-symbol metric by its associated noise variance or reliability estimate and then weighting it according to factors such as symbol confidence, per-monitoring-occasion weight tables, and redundancy coding parameters. The user equipment (UE) then aggregates these weighted metrics across all observed symbols within the current monitoring occasion and across corresponding symbols from prior occasions, thereby improving detection reliability through temporal diversity.

This soft-combining approach may be implemented as a weighted summation, a maximal-ratio combining (MRC) operation, or a log-likelihood ratio (LLR) computation, and can be further optimized by applying early-stop rules that trigger wake-up decisions as soon as the fused detection score exceeds a predefined threshold. The temporal combining capability is particularly advantageous in scenarios where the UE is unable to observe all symbols in a single occasion, as it allows partial information gathered over multiple occasions to collectively reach the detection confidence required to initiate a wake event.

In an additional embodiment, the method further comprises aggregating authentication sub-tokens that are transmitted across at least two monitoring occasions as part of the LP-WUS signaling procedure prior to validating an authenticated wake event. Each sub-token may represent a fragment of a cryptographic token or integrity checksum distributed over multiple occasions, such that the complete authentication value cannot be reconstructed from any single transmission. The UE stores each received sub-token and, once sufficient fragments have been collected, reassembles them to form the full authentication token.

The reassembled token is then validated using a lightweight integrity check or cryptographic function to confirm that the LP-WUS originates from a legitimate network source. This split-token mechanism significantly enhances security by requiring an attacker to successfully spoof multiple transmissions over time, while also enabling the UE to support low-latency wake-up decisions based on partial token information when configured. By combining detection metrics across monitoring occasions and verifying authentication through sub-token aggregation, the UE achieves both high detection reliability and robust security without compromising energy efficiency.

Specifically, in one option, the reassembled token is validated using existing lightweight cryptographic primitives already provisioned in the user equipment (UE) for NAS or RRC security. For example, the UE may use an HMAC function seeded with keys derived from the KASME or KAMF hierarchy, or may apply an AES-based integrity check with a reduced block length. By reusing existing keys and integrity routines, no new key management procedure is required, and backward compatibility with legacy LTE/NR security architecture is preserved.

In another embodiment, the split-token may be validated using a newly defined lightweight checksum or hash function signaled specifically for LP-WUS, such as a truncated CRC, a polynomial check, or a keyed XOR of the sub-token fragments. This approach reduces computation complexity in the low-power receiver path while still providing a level of spoofing resistance proportional to the token length. The network provisions the specific function identifier in the LPWUSPatternConfig message so that the UE applies the correct check at wake-up.

In a further embodiment, the network may signal a selection between reuse of existing integrity protection functions and use of a dedicated low-power function, based on the UE's reported PartialSymbolLPWUSCap capability. Devices with higher compute headroom may apply full cryptographic MAC validation using existing keys, while extremely constrained devices may be instructed to use a lighter-weight check combined with temporal redundancy (e.g., requiring two successive MOs to pass validation). This enables a scalable balance between security strength and power efficiency across heterogeneous devices.

Furthermore, the method further comprises reporting, from the user equipment (UE) to the radio access network (RAN) node, a symbol-availability profile that explicitly indicates, for each configured OFDM symbol position within the LP-WUS pattern, whether the UE expects to be able to monitor that symbol position during future monitoring occasions. The UE generates this profile by analyzing its internal scheduling constraints and historical activity patterns, including factors such as anticipated measurement gaps, uplink transmission windows, half-duplex operation limitations, bandwidth part (BWP) switching events, or periods of receiver inactivity.

When the UE performs a handover from a source cell to a target cell, the symbol-availability profile maintained by the UE is either directly transferred as part of the handover context or re-reported after completion of the handover. The source RAN node includes the most recent profile received from the UE in the Xn or NG interface signaling toward the target RAN node. By inheriting this information, the target cell can immediately optimize LP-WUS pattern assignment without waiting for new reporting, reducing the risk of missed wake-ups during mobility.

In another embodiment, the UE, upon completion of a handover or cell reselection, triggers an expedited symbol-availability report to the new serving base station. This refresh accounts for changes in measurement gaps, new scheduling conflicts, or updated slot-format rules specific to the target cell. The target gNB then adapts the LP-WUS configuration, accordingly, ensuring continuity of low-power wake signaling even across mobility events.

In a further embodiment, where the UE is served by relay nodes or dual connectivity, the symbol-availability profile is extended to include cell-specific availability maps. Each map indicates which OFDM symbol positions are available when scheduled by a particular donor gNB or relay. During handover, or when traffic is steered to a secondary cell, the new serving node can refer to the appropriate map. This enables seamless continuity of LP-WUS detection across multi-cell and relay scenarios.

The symbol-availability profile may be represented as a bitmap, a list of available and unavailable symbol indices, or a probabilistic confidence vector indicating the likelihood of successful observation for each configured symbol. In some implementations, the UE maintains separate availability profiles per carrier or frequency band in multi-band operation scenarios to account for differences in scheduling and interference conditions. This profile is transmitted to the RAN node during capability exchange, initial configuration, or periodically during operation, for example via a dedicated MAC control element or RRC signaling.

Specifically, the symbol-availability profile transmitted by the UE can be represented as a probabilistic confidence vector, where each entry corresponds to a configured OFDM symbol position and carries a numeric value between 0 and 1 indicating the likelihood of successful observation of that symbol. The UE computes this probability by analyzing historical statistics of symbol collisions, interference, measurement gaps, and half-duplex blocking events. For example, if a symbol is frequently overlapped with uplink sounding or BWP switching, its confidence value may converge toward 0.2, while symbols that have historically remained free of conflicts may retain values near 0.9 or higher.

Further, the RAN node may interpret the probabilistic confidence vector as weights in its LP-WUS scheduling logic. Symbols with high probability are preferentially selected for LP-WUS placement, whereas symbols with lower confidence values may either be excluded or assigned redundancy coding to offset their unreliability. This allows the gNB to adaptively allocate LP-WUS energy to those portions of the slot most likely to be observed by the UE without requiring full symbol exclusion.

The UE updates the probabilistic confidence vector over time using a sliding-window average or exponential smoothing filter. This ensures that the profile reflects recent conditions, such as changes due to mobility, interference, or slot-format updates. The updated vector is reported periodically or event-triggered (e.g., upon detection of a new conflict pattern) via MAC CE signaling. The RAN node then uses this updated probabilistic information to remap LP-WUS pattern symbols, thereby improving detection reliability in dynamic environments.

Upon receiving the symbol-availability profile, the RAN node may use the information to optimize future LP-WUS scheduling decisions by remapping wake-up symbol positions to indices with higher availability probability, adjusting redundancy levels, or altering monitoring occasion timing to maximize observability. The reporting procedure enables a closed-loop adaptation mechanism whereby network scheduling is informed by device-level awareness of symbol monitoring capability, ultimately improving detection reliability, reducing missed wake-up events, and enhancing the overall energy efficiency of the low-power wake-up mechanism.

Moreover, the method further comprises receiving configuration information from the radio access network (RAN) node that defines an LP-WUS pattern composed of non-contiguous OFDM symbol positions within a slot, enabling greater scheduling flexibility and improved coexistence with other downlink transmissions. Instead of allocating the wake-up waveform to a continuous block of symbols, the network distributes the LP-WUS energy across a sparse set of symbol indices, which may be interleaved with PDSCH data, CSI-RS signals, or other control channels.

This non-contiguous design allows the network to exploit unused or less interfered time-domain resources while minimizing the scheduling impact on ongoing traffic. The configuration information further specifies a minimum subset count parameter, which indicates the minimum number of LP-WUS symbols the user equipment (UE) must successfully monitor and detect to make a reliable determination of LP-WUS presence. For example, in a pattern consisting of four non-contiguous symbols, the minimum subset count may be set to two, allowing the UE to perform detection even if some symbols are blocked by measurement gaps, downlink collisions, or bandwidth part switching. During operation, the UE monitors the configured non-contiguous symbols that are available based on its symbol-availability profile and computes symbol-level detection metrics as described previously. If the number of successfully monitored and processed symbols meets or exceeds the configured minimum subset count, the UE proceeds with the soft-combining process and evaluates the fused detection score against the detection threshold. If fewer than the required number of symbols are available, the UE may defer detection to subsequent monitoring occasions or request reconfiguration from the network. This mechanism significantly improves detection reliability under practical operating conditions where symbol availability is unpredictable, while also providing the network with finer control over trade-offs between reliability, energy consumption, and resource utilization.

Additionally, the method further comprises adaptively adjusting the detection threshold used to decide LP-WUS presence based on statistical information about false alarms and missed detections collected by the user equipment (UE) over time. During regular operation, the UE maintains counters or sliding-window statistics that track the frequency of instances where the detection score exceeds the threshold without a corresponding valid wake-up signal (false alarms) as well as cases where scheduled wake-up signals were missed due to the detection score remaining below the threshold (missed detections). Using these statistics, the UE dynamically updates the detection threshold to maintain an optimal balance between sensitivity and specificity under varying radio conditions. For example, if the false alarm rate increases beyond a predefined threshold, indicating that noise or interference is frequently being misinterpreted as LP-WUS energy, the UE incrementally raises the detection threshold to reduce spurious wake-ups and conserve energy.

Specifically, in an implementation, the RAN node transmits threshold-related configuration parameters to the WTRU as part of an RRC reconfiguration or MAC control element. These parameters may include a baseline detection threshold, an allowed adjustment range, and a step size for raising or lowering the threshold in response to false alarms or missed detections. The WTRU then autonomously applies the adaptive thresholding logic within the signaled bounds, ensuring that local adaptation does not drift outside network-controlled limits. This provides the operator with predictable false-alarm rates across many UEs while still allowing device-side flexibility.

Thus, the WTRU periodically reports its false alarm statistics, missed detection counts, or per-MO detection confidence metrics to the RAN node in uplink control information. The RAN node aggregates this telemetry across multiple UEs and computes network-wide adaptation policies, then signals back an updated offset or multiplier for the threshold. This closed-loop mechanism allows thresholds to track cell-level interference conditions, traffic load, or SBFD slot-format usage while keeping reporting overhead compact.

In a further embodiment, the RAN configures the WTRU with multiple threshold profiles tied to service types or QoS flows. For example, for URLLC services the RAN may signal a more aggressive “low threshold” profile to reduce missed detections, while for best-effort traffic the WTRU may follow a more conservative “high threshold” profile to avoid unnecessary wake-ups. The WTRU indicates the currently active profile via a short MAC CE or piggybacked TLV, so that the network can interpret wake-up behavior consistently.

Conversely, if the missed detection rate rises, suggesting that legitimate wake-up signals are being overlooked due to channel degradation or reduced observability, the UE lowers the threshold to increase sensitivity and improve detection probability. This adaptive threshold adjustment may be further refined by weighting recent detection events more heavily than older ones, or by incorporating context such as measured signal-to-noise ratio (SNR), Doppler spread, or observed interference levels. The adaptation logic may also consider service-specific requirements, lowering the threshold for latency-critical services while raising it for energy-prioritized use cases. By continuously tuning the detection threshold based on real-time performance feedback, the UE achieves a self-optimizing detection mechanism that maintains reliable wake-up performance across diverse radio environments, dynamic scheduling conditions, and device activity states.

When the fused detection score computed from the available LP-WUS symbol metrics does not exceed the configured detection threshold, evaluating a missed-detection risk metric that quantifies the likelihood that a wake-up signal was transmitted but not detected. This risk metric may be derived from a combination of factors including historical detection performance, the number of symbols successfully observed in the current monitoring occasion, recent channel quality measurements, and service priority indicators. If the missed-detection risk is determined to be below a configurable threshold, indicating that the consequences of a missed wake-up are minimal or that additional combining is likely to improve detection confidence, the user equipment (UE) defers activation of its main receiver chain and remains in a low-power state. Instead of immediately declaring a non-detection event, the UE continues to accumulate detection metrics from subsequent monitoring occasions and re-computes the fused detection score as new symbol-level information becomes available.

This approach enables the UE to avoid unnecessary power consumption associated with false alarms while still providing a mechanism to recover missed detections over time, particularly in scenarios where symbol availability is sparse or channel conditions fluctuate. Conversely, if the risk metric indicates that missed detection carries significant service impact, such as for latency-sensitive traffic, the UE may bypass deferral and initiate ramp-up despite a sub-threshold detection score.

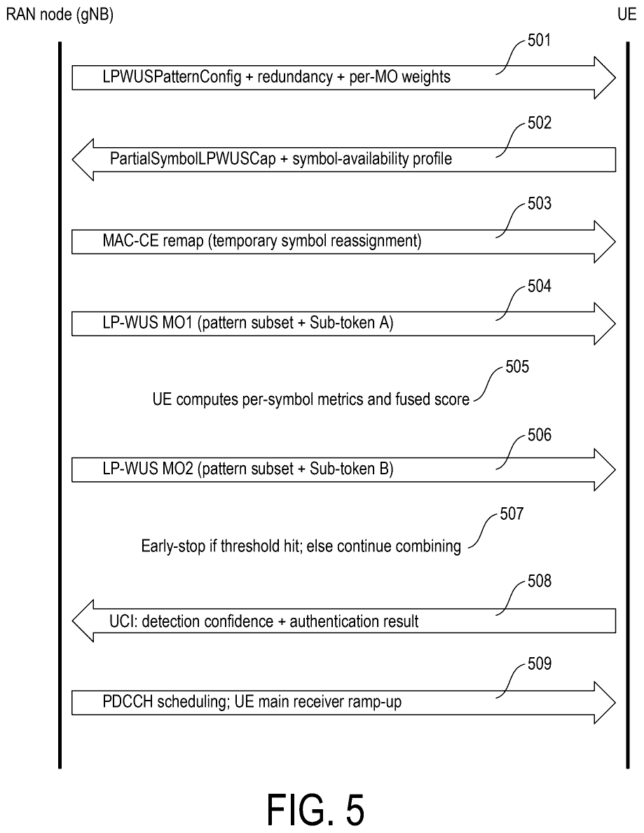

FIG. 5 illustrates an example low-power wake-up signaling (LP-WUS) flow in which a network configures a UE to monitor one or more partial-symbol wake patterns and to combine evidence across monitoring opportunities to reach a wake decision while minimizing receiver on-time. At 501, a radio access network (RAN) node transmits a configuration that establishes an LP-WUS detection framework, including a pattern description, one or more monitoring occasions, and one or more parameters for detection and combining. At 502, the UE provides capability information indicating whether it supports partial-symbol detection and, in some implementations, one or more constraints describing which symbols, sub-symbols, or resource subsets the UE can reliably observe under reduced-power operation. At 503, the RAN node transmits an update that remaps or refines one or more monitoring resources, such as by shifting a monitoring occasion, changing a resource subset, selecting a code index, or adjusting a combining depth, thereby adapting the LP-WUS monitoring plan without requiring re-attachment or a full reconfiguration cycle.

At 504, the RAN node transmits a first LP-WUS instance on a first monitoring occasion, which may include a first portion of a multi-part token or authentication element and may be limited to a subset of symbols within the occasion. At 505, the RAN node transmits a subsequent LP-WUS instance on a second monitoring occasion, which may include a second portion of the token and may occupy a different subset of symbols or resource subset than the first instance. At 506, the UE transmits an uplink indication reflecting detection status, which may include a confidence value, an authentication result, or a request for additional combining opportunities when the evidence is insufficient. At 507, responsive to a positive detection outcome, the RAN node schedules follow-on control or data signaling and the UE transitions from a reduced-power monitoring state to an active receive state to monitor scheduling and receive a pending transmission.

At 508, the UE computes one or more per-symbol or per-subset detection metrics and fuses the metrics across the observed portions of the monitoring occasions into a combined detection score, such as by applying variance normalization, weighted accumulation, or a log-likelihood update. DL multiplexing: PDSCH overlay/CORESET-aware/code-domain separation.

At 509, the UE applies an early-stop rule in which combining is terminated when the combined detection score satisfies a configured threshold, while otherwise continuing to accumulate evidence across additional monitoring occasions up to a configured combining depth or decision deadline, thereby reducing unnecessary wakeups and limiting receiver activity when a reliable decision has already been reached.

In embodiments SSB-adjacent placement may be optional; modest power boost within EVM bounds. By collecting detection confidence metrics across many UEs and monitoring occasions, the RAN node gains insight into factors such as symbol observability, interference impact, or detection performance under various scheduling patterns. It can then use this information to dynamically adjust LP-WUS configurations, such as selecting different symbol positions, modifying per-monitoring-occasion weights, increasing redundancy, or adapting split-token distribution across time. This closed-loop optimization process ensures that future LP-WUS transmissions are better aligned with device capabilities and real-time network conditions, improving detection reliability and reducing the risk of missed wake-up events while maintaining efficient use of radio resources.

The fused detection score generated from the aggregation of symbol-level detection metrics to a predefined detection threshold to determine whether a valid low-power wake-up signal (LP-WUS) is present. The fused detection score, which may be computed as a weighted sum, log-likelihood ratio, or normalized correlation metric across multiple monitored OFDM symbols and potentially across multiple monitoring occasions, represents a probabilistic measure of signal presence relative to noise and interference. Upon computing this score, the user equipment (UE) evaluates it against one or more thresholds configured by the radio access network (RAN) node or adaptively updated by the UE based on detection performance history. If the fused detection score exceeds the high-confidence threshold, this indicates with sufficient reliability that the LP-WUS has been transmitted and successfully detected. In response, the UE transitions from its low-power state into an active reception state by initiating a main receiver ramp-up procedure.

This procedure involves powering up the full RF and baseband processing chains, expanding the receiver's active bandwidth if needed, and preparing the physical layer to decode higher-layer control signaling, such as the physical downlink control channel (PDCCH), that may immediately follow the wake-up event. The ramp-up process may also include synchronization refinement, frequency and timing tracking, and channel estimation to ensure that subsequent control and data receptions occur with minimal delay and high reliability. Conversely, if the fused detection score remains below the threshold, the UE may maintain its low-power state, continue monitoring future symbols, or apply additional combining across subsequent monitoring occasions. By tightly coupling the detection decision to a quantitative fused score and using that decision as a trigger for receiver activation, the method ensures that the UE wakes only when necessary, thereby minimizing unnecessary power consumption while still guaranteeing rapid responsiveness to downlink traffic.

In an additional embodiment, the UE may support intermediate ramp-up states where only a portion of the RF and baseband chain is powered. For example, the RF front-end and frequency tracking unit may be powered up sufficiently to capture and decode synchronization signals or narrowband control reference signals, while the wideband channel estimation block and full demodulator remain off. This enables the UE to confirm imminent PDCCH/downlink control activity without committing to the higher energy cost of decoding full data channels. If subsequent conditions confirm a wake event, the UE escalates to full ramp-up; otherwise, it powers back down to the low-power monitoring state.

Further, the UE may configure its receiver to apply different gain and bandwidth settings depending on the type of signal being targeted. The UE may, for example, ramp up power to a medium state that allows reliable reception of LP-WUS or synchronization signals, but does not allocate enough baseband resources to decode broadband PDSCH. This permits fast reaction to wake-up cues while preserving energy by avoiding unnecessary full-bandwidth reception.

In a further embodiment, the ramp-up and ramp-down processes are asymmetric, with the UE powering up quickly to receive critical wake-related control information and then entering a controlled partial power-down state that leaves timing/frequency tracking active. This allows the device to maintain synchronization with minimal power while deferring the high-cost decoding functions until the network signals urgent traffic. Such asymmetric control reduces repeated full power cycling, smoothing energy consumption during bursty traffic.

In yet another embodiment, the RAN node signals, via LPWUSPatternConfig or a MAC-CE, which receiver power profile the UE should apply after tentative detection. For example, a “light ramp-up” mode may suffice for PDCCH monitoring only, whereas a “full ramp-up” mode is required for imminent data reception. This allows the network to tailor UE energy use to service requirements while preserving the reliability of wake-up detection.

On the RAN node side, it transmits a low-power wake-up signal (LP-WUS) to at least one user equipment (UE) which includes transmitting configuration information that defines an LP-WUS pattern mapped across a plurality of OFDM symbol positions within a slot, along with associated redundancy coding parameters that enhance detection robustness. This configuration may be delivered via a dedicated RRC message and includes details such as the specific symbol indices carrying wake-up energy, the number of monitoring occasions per discontinuous reception (DRX) cycle, repetition factors, parity bit allocation, and optional split-token authentication scheduling.

The LP-WUS pattern may be designed as a non-contiguous set of symbols interleaved with other downlink transmissions to maximize spectral efficiency and minimize interference with ongoing PDSCH, CSI-RS, or SSB signaling. The RAN node may further tailor the pattern to the symbol-availability profile previously reported by the UE, selecting symbol positions that are more likely to be observed and remapping them dynamically using a MAC control element if necessary. Additionally, the method comprises signaling a per-monitoring-occasion weight table that assigns reliability weights to each configured monitoring occasion based on network-side knowledge such as interference measurements, beam alignment quality, expected scheduling conflicts, or historical detection performance.

As shown by the exemplary TABLE 1, the RAN node transmits a per-monitoring-occasion weight table that specifies reliability weights for each configured monitoring occasion within a DRX cycle. These weights are derived from network-side measurements such as observed interference levels, expected scheduling conflicts, or beam quality. For instance, a first monitoring occasion might occur during a period with minimal interference and strong beam alignment and therefore be assigned a higher weight, while a second monitoring occasion occurring during a busy slot with CSI-RS multiplexing may be assigned a lower weight. The UE multiplies its per-symbol detection metrics by the corresponding occasion weight before combining, thereby biasing its detection decision toward more reliable observations.

TABLE 1
Exemplary weight table signaling.

| Monitoring | Configured | Interference | Network | Assigned |
|---|---|---|---|---|
| Occasion | Symbol | Level | Reliability | Weight |
| (MO) | Indices | (dB) | Assessment | (0-1) |
| MO#1 | {2, 5, 9} | −92 | High reliability | 0.9 |
| | | | (clean slot) | |
| MO#1 | {3, 7} | −87 | Medium | 0.6 |
| | | | reliability | |
| MO#3 | {4, 8, 10} | −70 | Low reliability | 0.3 |
| | | | (conflicts) | |

These weights are transmitted alongside the LP-WUS configuration and guide the UE in weighting symbol-level detection metrics during the soft-combining process, ensuring that measurements from more reliable occasions contribute more significantly to the final detection decision. In more advanced implementations, the RAN node may also encode SBFD-aware symbol reservation rules, specify PRB-subset mappings to control multiplexing with other downlink signals, and assign orthogonal or low-correlation codes to UEs sharing the same time-frequency region to enable code-domain separation. By transmitting detailed configuration information and per-occasion weighting instructions, the RAN node enables efficient and reliable wake-up signaling that is optimized for real-time radio conditions, device capabilities, and service requirements while maintaining backward compatibility with legacy devices.

Thus, the RAN node receives, from the user equipment (UE), a symbol-availability report that indicates, for each configured OFDM symbol position within the LP-WUS pattern, whether the UE expects to be able to monitor that symbol during upcoming monitoring occasions. This report may be generated based on the UE's internal scheduling constraints, including known measurement gaps, uplink transmission periods, half-duplex operation, and bandwidth part switching events. Upon receiving this report, the radio access network (RAN) node analyzes the reported availability information and generates a medium access control (MAC) control element (CE) that temporarily remaps one or more LP-WUS symbol assignments for that specific UE. This remapping operation involves reassigning LP-WUS energy to symbol positions with higher availability likelihood while preserving the overall wake-up pattern structure and maintaining coexistence with other downlink signals. The temporary nature of the remapping ensures that future network-wide resource allocation remains flexible and that adjustments can be reverted or updated dynamically based on subsequent UE reports. Additionally, the remapping process may consider other parameters such as per-symbol interference measurements, ongoing traffic load, or SBFD-related symbol reservations, thereby optimizing wake-up signal reliability and reducing missed detection probability in real time.

Accordingly, the RAN node may additionally multiplex multiple LP-WUS patterns for multiple UEs within a shared symbol region using code-domain separation techniques to reduce collisions and interference. When multiple devices are scheduled to receive wake-up signals in overlapping time-frequency resources, the RAN node assigns each UE a distinct orthogonal or low cross-correlation code, which is applied to the LP-WUS waveform transmitted on the shared symbols. The codes may be based on orthogonal variable spreading factors (OVSF), Zadoff-Chu sequences, or Gold codes, and are chosen to maintain mutual isolation and minimize cross-interference even when received simultaneously. The assignment of codes is signaled to the UE during RRC configuration, for example as part of the LPWUSPatternConfig message, and may be updated through a MAC control element if dynamic reassignment is required during operation.

This code-domain separation enables the RAN node to efficiently utilize available spectrum by overlapping LP-WUS transmissions for multiple UEs without requiring dedicated symbol allocations for each device, thereby improving system capacity and scalability. Furthermore, the code index assigned to each UE may be signaled as part of the LPWUSPatternConfig and can be dynamically updated as network conditions change, for example to optimize code reuse or to account for changing interference conditions. By combining temporary symbol remapping with code-domain multiplexing, the RAN node achieves highly adaptive and resource-efficient wake-up signaling, ensuring that LP-WUS reliability, energy efficiency, and collision resistance are maintained even in dense network deployments.

Thus, in one variant, the RAN node may configure the UE such that the same code index assigned for LP-WUS multiplexing is also reused for subsequent high-power transmissions, such as control channel preambles or service-specific wake-up acknowledgments. This continuity of code assignment allows the UE to seamlessly transition from low-power wake detection to high-power reception without re-initializing its de-spreading or code-correlation logic, thereby reducing latency and complexity in the wake-up process. For example, after detecting its LP-WUS sequence with a specific Zadoff-Chu root index, the UE continues to apply the same de-spreading filter when monitoring the PDCCH region that immediately follows.

Therefore, the UE maintains its low-power receiver path and the associated code de-spreader active for a defined guard interval after the high-power RF/baseband chain has been ramped up. During this overlap, the LP receiver continues to track code-domain energy to validate that the wake-up event originated from the legitimate network and to detect any residual overlapping wake-up patterns intended for relays or neighboring cells. The high-power receiver in parallel begins decoding system control signals. This dual-path operation ensures authentication continuity while enabling faster readiness for data reception.

The code spreading codes initially assigned for LP-WUS may also be reused by relay nodes or cooperating base stations to tag their subsequent high-power transmissions. When the UE is woken by a relay, the same spreading code can be observed both in the LP-WUS symbol region and in the first control messages from the relay, providing a consistent association between low-power detection and high-power reception. This improves robustness in multi-cell or cooperative deployments by preventing confusion between overlapping LP-WUS signals from different transmitters.

The RAN node also selects, for each LP-WUS periodicity, which user equipments (UEs) receive full redundancy of the wake-up signal and which receive reduced redundancy based on per-UE quality of service (QoS) requirements, radio conditions, and interference constraints. The radio access network (RAN) node performs this selection dynamically by evaluating criteria such as the latency sensitivity of the service associated with each UE, historical detection performance, channel quality indicators, and the density of UEs scheduled within the same time-frequency region. UEs requiring stringent reliability, such as those carrying mission-critical or ultra-reliable low-latency communications (URLLC) traffic, may be assigned full redundancy where all configured LP-WUS symbols are transmitted across multiple monitoring occasions, thereby maximizing detection probability even under adverse conditions. Conversely, UEs engaged in delay-tolerant or best-effort traffic may be assigned reduced redundancy, in which only a subset of the total LP-WUS symbols or monitoring occasions are used, conserving radio resources and minimizing interference to other downlink signals. This adaptive redundancy assignment enables the network to efficiently balance resource utilization, reliability, and energy efficiency across a heterogeneous set of devices while dynamically responding to changing radio conditions and traffic demands.

The RAN node further instruct UEs, via a radio resource control (RRC) signaling procedure, to report a per-service collision policy that indicates how the UE should behave if a scheduled monitoring occasion is missed. This collision policy allows the network to adapt wake-up detection behavior to different service priorities and application requirements. For example, the RRC signaling may specify whether the UE should default to an “assume detected” mode, where it treats the missed occasion as if a wake-up signal was received and prepares for subsequent control channel monitoring, or an “assume not detected” mode, where it remains in a low-power state until the next scheduled opportunity. The choice of policy may depend on service characteristics such as latency tolerance, energy constraints, or the criticality of missed downlink data. Once configured, the UE encodes its selected collision policy in uplink control information or periodic capability reports, enabling the RAN node to coordinate scheduling and redundancy strategies accordingly. This mechanism ensures that wake-up signaling remains aligned with per-service requirements while minimizing the risk of either unnecessary wake-ups or delayed data reception, improving overall system responsiveness and energy efficiency.

On condition of an active sub-band full duplex (SBFD) operation, and in one embodiment, a radio access network node may configure an SBFD-aware LP-WUS symbol reservation that maps each slot type and numerology to a distinct set of candidate OFDM symbol indices and optional PRB subsets reserved for wake-up signaling, and signals this mapping to a user equipment as part of LPWUSPatternConfig.

For example, for DL-only slots the reservation allows a wider non-contiguous set of symbols late in the slot to permit immediate PDCCH follow-on, whereas for flexible (F) slots the reservation excludes symbols overlapped by the UL portion and guard periods defined by the SBFD slot format, and for mini-slot scheduling the reservation restricts LP-WUS to the mini-slot's interior symbols. The gNB selects the LP-WUS pattern from the per-slot-type reservation table at runtime in accordance with the active SBFD configuration, while the UE uses the same table to form its symbol-availability profile and to limit monitoring to the reserved indices; temporary deviations for interference avoidance are conveyed by a MAC-CE remap that preserves SBFD constraints.

In another embodiment, the gNB resolves collisions between LP-WUS and other downlink signals under SBFD by applying a per-slot-type puncturing budget and a scheduler priority policy that favors reserved LP-WUS symbols in DL slots but defers to CORESET/CSI-RS occupancy in flexible slots, with any displaced LP-WUS energy relocated to alternative reserved symbols within the same slot or to the next monitoring occasion. The reservation additionally encodes coexistence rules whereby LP-WUS may overlay PDSCH only in DL slots subject to an error-vector-magnitude limit and may only use code-domain separation when sharing reserved symbols with another UE; the UE reflects these policies by weighting symbol-level metrics according to slot type and reported coexistence, thereby ensuring soft-combining remains consistent with SBFD scheduling while maintaining early-stop behavior when a minimum subset from DL-preferred symbols is detected.

In a further embodiment, multiple SBFD configurations are pre-provisioned, each with a corresponding LP-WUS reservation table keyed to the TDD pattern and slot-format set active in the cell, and the gNB switches the applicable table via RRC or DCI when the SBFD configuration changes. Upon switch, the UE immediately updates its monitoring windows to the new per-slot-type reserved symbols and applies a per-slot-type minimum-subset parameter so that, for example, fewer symbols are required in DL slots with contiguous reservations while more symbols are required in flexible slots with sparser reservations; split-authentication sub-tokens are distributed across slot types so that at least one fragment is scheduled in a DL slot to enable low-latency fast-wake and any remaining fragments are placed in reserved symbols of subsequent flexible or mini-slots to complete authenticated wake without violating SBFD constraints.

A method performed by a UE for detecting a low-power wake-up signal (LP-WUS) may comprise receiving, from a radio access network node, configuration information that identifies a plurality of OFDM symbol positions that together form an LP-WUS pattern for at least one monitoring occasion; monitoring a subset of the plurality of OFDM symbol positions that are available to the UE; generating, for each monitored OFDM symbol position, a symbol-level detection metric indicative of LP-WUS energy or correlation on the monitored symbol; combining the symbol-level detection metrics across the monitored subset and across at least one previous monitoring occasion to produce a fused detection score; comparing the fused detection score to a detection threshold; and initiating a main receiver ramp-up procedure when the fused detection score exceeds the detection threshold.

The configuration information further specifies redundancy coding parameters for the LP-WUS pattern and wherein combining the symbol-level detection metrics comprises applying soft-combining accounting for the redundancy coding parameters.

Receiving from the radio access network node a per-monitoring-occasion weight table and using the per-monitoring-occasion weights in computing the fused detection score.

Aggregating authentication sub-tokens that are carried across at least two monitoring occasions prior to validating an authenticated wake event.

Reporting to the radio access network node a symbol-availability profile that indicates, per configured symbol position, whether the UE expects to be able to monitor that symbol position.

The LP-WUS pattern may comprise non-contiguous OFDM symbol positions within a slot and wherein the configuration information defines a minimum subset count of pattern symbols that the UE may use to determine presence of the LP-WUS.

Combining the symbol-level detection metrics comprises performing weighted voting and applying an early-stop criterion to reduce monitoring latency and energy consumption.

Adaptively adjusting the detection threshold based on recent false alarm and missed detection statistics collected by the UE.

When the fused detection score does not exceed the detection threshold and a missed-detection risk metric is acceptable, deferring receiver ramp-up and continuing to perform combining across subsequent monitoring occasions.

The UE reporting per-MO detection confidence metrics to the radio access network node as part of uplink control information so that the radio access network node adapts future LP-WUS scheduling.

A method performed by a radio access network node for transmitting a low-power wake-up signal to at least one UE may comprise transmitting configuration information that defines an LP-WUS pattern mapped across a plurality of OFDM symbol positions and redundancy coding parameters; signaling a per-monitoring-occasion weight table for the LP-WUS; scheduling LP-WUS transmissions across Z monitoring occasions per periodicity using the LP-WUS pattern; and varying which symbol subset carries authentication sub-tokens across the Z monitoring occasions to permit split authentication.

Receiving from the UE a symbol-availability report and generating a MAC control element that temporarily remaps LP-WUS symbol assignments for that UE based on the reported symbol availability.

Multiplexing LP-WUS patterns for multiple UEs in a shared symbol region using code-domain separation to reduce collisions.

Selecting, for each periodicity, which UEs receive full LP-WUS redundancy and which UEs receive reduced redundancy based on per-UE QoS and interference constraints.

Instructing UEs via RRC to report a per-service collision policy indicating whether the UE should default to “assume detected” or “assume not detected” when a scheduled monitoring occasion is missed.

A User Equipment (UE) for detecting a low-power wake-up signal (LP-WUS), the UE comprising: a low power receiver; a high power receiver, wherein the higher power receiver consumes higher power than the low power receiver; the high power receiver configured to receive, from a radio access network node, configuration information that identifies a plurality of OFDM symbol positions that together form an LP-WUS pattern for at least one monitoring occasion; with the high power receiver in a power down or low power state: the low power receiver is configured to monitor for a subset of the plurality of OFDM symbol positions that are available to the UE; circuitry is configured to generate, for each monitored OFDM symbol position, a symbol-level detection metric indicative of LP-WUS energy or correlation on the monitored symbol; circuitry is configured to combine the symbol-level detection metrics across the monitored subset and across at least one previous monitoring occasion to produce a fused detection score; circuitry is configured to compare the fused detection score to a detection threshold; and circuitry is configured to initiate a main receiver ramp-up procedure when the fused detection score exceeds the detection threshold.

A Bluetooth LE central device configured to: transmit a wake-up preamble encoded over multiple advertising channels, each carrying a sub-token of an authentication value. A peripheral device equipped with a low-power wake-up receiver monitors only a subset of advertising events and/or channels, due to duty-cycling or overlapping transmissions. The peripheral device soft-combines correlation energy across observed sub-tokens to reconstruct an authentication token. By aggregating across multiple advertising intervals, the peripheral can validate wake-up without requiring continuous monitoring and may perform wake up.

A method and apparatus for detecting a low-power wake-up signal (LP-WUS) in a wireless communication system are disclosed. Configuration information defining a plurality of OFDM symbol positions forming an LP-WUS pattern, associated redundancy coding parameters, and per-monitoring-occasion weights is received by a user equipment (UE). A subset of symbol positions that are available to the UE is monitored, and symbol-level detection metrics are generated and combined across the monitored subset and previous monitoring occasions to produce a fused detection score. The score is compared to a detection threshold, and a main receiver ramp-up is initiated when the threshold is exceeded. Authentication sub-tokens transmitted over multiple occasions may be aggregated to validate wake-up events. Symbol-availability profiles and detection confidence metrics may be reported to a radio access network (RAN) node, which adapts LP-WUS scheduling, remaps symbol assignments, and multiplexes multiple UEs using code-domain separation to enhance detection reliability and energy efficiency.

Time-division duplexing (TDD) is an attractive duplex mode for non-terrestrial networks (NTNs) because it reuses a single carrier for both downlink and uplink, simplifies device RF design (valuable for low-cost NB-IoT endpoints), and allows the network to flexibly bias DL/UL capacity as service demand and satellite payload constraints change. TDD also eases spectrum coordination with terrestrial deployments by enabling common carriers and time-based separation, which is especially relevant where NTN and terrestrial cells share bands or must align with regional frame structures.

However, applying TDD to NB-IoT over satellites introduces practical issues that do not arise in terrestrial TDD. Large propagation delays, Doppler dynamics, and timing uncertainty motivate elongating the scheduling horizon into a repetitive multi-frame pattern (e.g., a ~90 ms period) and inserting wider guard intervals around DL↔UL boundaries. The resulting frame map is fragmented: many subframes that NB-IoT procedures expect for system information (SI) reception, NPDCCH monitoring, or preconfigured uplink (PUR/UL-SPS) transmission are simply not available in a given period. Nominal SI anchors can land in non-DL windows, causing missed or ambiguously postponed broadcasts; control-channel monitoring configured under the assumption of continuous DL forces needless UE wakeups and battery drain; and scheduled UL occasions that fall in non-UL windows leave devices uncertain whether to buffer or drop data and how long to retain deferred PDUs. These effects are amplified for deep-coverage and emergency-mode devices that require higher SI repetition or stricter delivery guarantees. Additionally, coexistence with legacy terrestrial TDD requires guard-period planning and, in some cases, per-UE adjustments so that satellite timing advance and terrestrial boundaries do not collide. Without explicit network signaling and deterministic UE behaviors tailored to the fragmented TDD map, these conditions lead to SI unreliability, excess retransmissions, wasted energy, and prolonged loss of synchronization for NB-IoT devices operating in NTNs.

A radio access network (RAN) node operating in an NB-IoT TDD-based satellite system determines that certain system information (SI) anchor subframes coincide with subframes unavailable for downlink in a 90 ms repeating frame structure. In response, the RAN computes postponed delivery points for the affected SI types by selecting the next valid downlink subframe within the permitted SI window and constructs a compact SI-PostponeDescriptor including the original anchor index, a signed postpone offset, and a modulo-siSeq continuity identifier. This descriptor is inserted into a short periodic SIB or embedded in the primary SIB1 broadcast and is transmitted such that all connected and idle UEs can deterministically resolve the new anchor locations.

A wireless device configured for NB-IoT operation in a satellite TDD cell receives a broadcast SI-PostponeDescriptor indicating that the nominal anchor for a particular system information type has been postponed. Upon decoding the descriptor, the device calculates the effective anchor by adding the postponeOffset to the original anchor index and restricts its SI monitoring behavior to only the computed downlink subframe. If the received siSeq matches or exceeds the last successfully decoded value, the device accepts the SI instance and updates its record; otherwise, it discards the repetition as a duplicate, thereby conserving energy and avoiding unnecessary processing.

A RAN node collects compact CoverageReports from a plurality of NB-IoT devices, each indicating the device's estimated coverage class and the last successfully decoded SI sequence number. Based on the distribution of reported coverage classes, the RAN consults an SI_AdaptationPolicy table to determine the required repetition factor, transport block size, and anchor placement preference for each class. The RAN then applies these parameters to schedule and boost SI messages accordingly, ensuring that deep-coverage devices receive enhanced repetition and favorable timing alignment without requiring per-device unicast signaling.

During RRC configuration of a preconfigured uplink resource (PUR) for an NB-IoT device, the RAN node includes a per-resource field deferredTxAllowed set to TRUE and configures a defer-expiry timer of 640 ms. If the PUR's scheduled uplink occasion falls in a subframe not designated for uplink in the current 90 ms TDD map, the RAN expects the device to locally buffer the MAC PDU without physical transmission and wait for a future uplink grant that explicitly references the deferred buffer. The RAN later issues a MAC control element containing a deferredTag and HARQ process ID, prompting the device to flush the buffer for actual transmission.

An NB-IoT wireless device configured with deferredTxAllowed behavior for a UL-SPS resource detects that the next scheduled transmission occasion falls within a subframe that is not valid for uplink under the current TDD pattern. The device assembles the MAC PDU as usual, assigns a 4-bit deferredTag, stores it in a local HARQ buffer, and starts a deferExpiryMs countdown. If the RAN issues a valid consumeDeferred command referencing the tag and HARQ process before the timer expires, the device transmits the buffered data. Otherwise, if the timer elapses without instruction, the device discards the PDU and optionally logs the discard in a diagnostic report sent with the next uplink transmission.

To prevent timing collisions between downlink and uplink transmissions in an NB-IoT satellite system coexisting with terrestrial TDD networks, the RAN node determines a guardPeriodMs value based on the satellite's timing uncertainty and Doppler profile, and includes it in a broadcast GuardPeriodDescriptor. For devices that signal precise timing capabilities such as GNSS or stable oscillator references, the RAN may transmit a per-UE override via dedicated RRC signaling, shrinking the guard interval for that device to reclaim usable uplink symbols while maintaining system integrity for legacy devices.

A wireless device operating in a TDD-based NTN further reads the NPDCCHMonitorSchedule broadcast message containing a 9-bit dWindowBitmap and a 2-bit defaultScaling factor of 4. The device determines which of the downlink subframes in each 90 ms cycle are valid monitoring opportunities and computes its scaled monitoring pattern accordingly. As a result, if the base monitoring periodicity is 320 ms, the device wakes only once every 1.28 seconds and only during downlink-valid windows, thereby substantially reducing receiver activity and extending battery life without compromising reception of necessary control messages.

A RAN node maintains an SI-DeliveryContract for SIB1, targeting coverage class C2 with a delivery guarantee of K=3 out of every L=5 SI windows. The scheduler analyzes the current TDD subframe availability and determines that only two valid anchor opportunities remain within the next 5 SI periods. In response, the node escalates delivery by inserting a boosted SIB1 transmission in a highly favorable downlink subframe and increases its repetition count for class C2. The SI-PostponeDescriptor is updated to reflect the modified anchors, and the escalation action is tracked in telemetry logs for potential breach notification if the contract is still unmet.

A device configured for NB-IoT operation fails to detect a valid SI-PostponeDescriptor for an upcoming SI window, possibly due to missed decoding or delayed update. The device applies a fallback rule defined by a broadcast fallbackRuleID, which instructs it to monitor the next two available downlink subframes within the nominal SI delivery window. If a successful decode occurs, the device updates its local siSeq tracker; otherwise, it includes a fallbackUsed flag in its next CoverageReport to inform the network of the ambiguity, enabling future broadcast corrections or parameter tuning.

In an embodiment, a method performed by a radio access network (RAN) node for providing service to narrowband Internet of Things (NB-IoT) devices in a time-division duplex (TDD) network comprises determining, for a repeating radio frame period, which subframes are to be treated as downlink-capable and which subframes are reserved for uplink or are otherwise unusable.

The RAN node begins by establishing a repetitive TDD pattern suitable for non-terrestrial network (NTN) operation, typically spanning a 90 ms super-frame composed of multiple 10 ms frames, and parses the applicable configuration-either preloaded, provisioned via OAM, or derived from NTN-specific timing constraints. The node then analyzes subframe-level duplexing information to determine, for each subframe within the repeating pattern, whether it is scheduled for downlink (D), uplink (U), special(S), or guard period usage. The determination accounts for satellite-specific constraints, including extended propagation delay, timing advance tolerances, Doppler uncertainty, and necessary guard margins to avoid overlap between satellite-transmitted downlink bursts and terrestrial or device-originated uplink transmissions. Subframes that are too close to the DL->UL or UL->DL boundaries may be excluded from effective scheduling, and optional per-UE refinements may be applied when the RAN has knowledge of a device's synchronization accuracy.

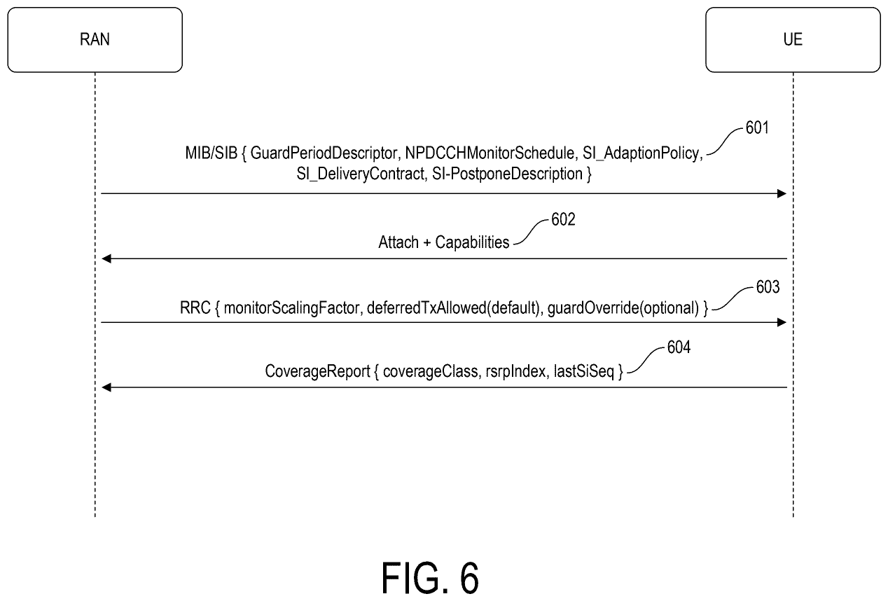

FIG. 6 illustrates RAN-UE capability signaling exchange for enabling dynamically deferred uplink. As shown by the signaling diagram of FIG. 6, the resulting classification of subframes into downlink-valid, uplink-valid, or guard zones forms the basis for all subsequent scheduling and signaling decisions, including whether a scheduled system information transmission, control message, or uplink opportunity must be postponed, replaced, or deferred. The downlink/uplink availability mapping is periodically updated and embedded in one or more broadcast information elements 601, such as the NPDCCHMonitorSchedule or GuardPeriodDescriptor, to ensure that all NB-IoT devices operating under the satellite TDD configuration can correctly interpret when to receive and transmit without violating timing protections or wasting energy monitoring unavailable subframes.

The UE transmits attach+capabilities 602 to the RAN, receives RRC information 603 and transmits coverageReport(s) 604.

The RAN node, having previously determined the set of subframes available for downlink transmission within a repeating TDD frame period, evaluates the scheduling configuration of system information (SI) and control-channel transmissions—such as Master Information Blocks (MIB), System Information Blocks (SIBs), or NPDCCH configurations—to identify any anchor points that are nominally assigned to subframes which are unavailable for downlink under the current frame structure. The RAN references the legacy SI anchor mapping, which defines the periodicity and subframe indices at which each SI type is scheduled to be broadcast, and cross-checks these indices against the computed downlink subframe map. If any of the scheduled SI anchors fall within subframes marked as uplink-only, special-use, or reserved for guard periods, the RAN marks those SI anchors as “conflicted” or “invalid” for direct downlink use.

Similarly, for NPDCCH or other control configurations that presume availability of continuous downlink subframes, the RAN examines whether configured monitor windows align with valid downlink opportunities in the pattern; any misaligned or fragmented opportunities are flagged for adjustment. This identification step may further be enhanced by verifying whether the postponed transmission can still fall within the allowed SI delivery window, and by associating the invalid anchor with a continuity sequence index to support deterministic behavior at the device side. The result of this analysis is used to construct SI-PostponeDescriptors for conflicted SI blocks and to update the NPDCCHMonitorSchedule so that devices are made explicitly aware of which control and broadcast anchors are postponed or reallocated, thereby preventing missed receptions, duplicate decodings, and unnecessary wakeups in satellite-based NB-IoT deployments.

Upon identifying that a scheduled system information (SI) or control anchor falls within a subframe that is unavailable for downlink transmission under the current TDD frame structure, the radio access network (RAN) node selects an alternative downlink subframe within a defined SI delivery window for the delivery of the affected transmission. This selection process begins with identifying the temporal bounds of the SI delivery window associated with the specific SI type, such as a fixed or configurable repetition interval defined in the system configuration (e.g., 160 ms for SIB1). Within this window, the RAN searches for the nearest subsequent subframe that is marked as a valid downlink opportunity in the current 90 ms duplexing map and that does not violate any repetition timing constraints or exceed allowable delays.

If multiple candidate subframes are available, the RAN may prioritize based on criteria such as guard distance from uplink edges, Doppler margin favorability, or slot alignment with expected device wakeup patterns. Once an appropriate subframe is selected, the RAN encodes the offset between the original anchor and the newly selected subframe into a compact postponeOffset field and associates it with the corresponding SI type in the SI-PostponeDescriptor, along with a continuity identifier (siSeq) that enables devices to suppress duplicate receptions. For control anchors such as NPDCCH monitor windows, a similar process is followed by updating the NPDCCHMonitorSchedule to reflect the re-aligned valid downlink windows for control reception. This ensures that both system information and control messages are transmitted in subframes that are guaranteed to be observable by devices under the satellite TDD configuration, thereby maintaining reliable broadcast coverage and predictable device behavior despite the fragmented downlink availability imposed by non-terrestrial timing constraints.

The RAN, having selected one or more alternative downlink subframes to replace unavailable system information (SI) or control anchors, broadcasts to devices a compact and deterministic representation of the modified scheduling using standardized signaling mechanisms. Specifically, the RAN constructs a System Information Postponement Descriptor, referred to as SI-PostponeDescriptor, which is embedded in a Master Information Block (MIB), a System Information Block (SIB), or a dedicated short periodic SIB depending on the SI type and system configuration. This descriptor contains, for each affected SI instance, a mapping between the original anchor index and a signed postponeOffset indicating the new relative subframe within the current delivery window, along with a siSeq continuity identifier that ensures devices can distinguish fresh versus repeated SI deliveries.

In parallel, for modified control scheduling, such as NPDCCH opportunities realigned to valid downlink slots, the RAN updates the NPDCCHMonitorSchedule, which includes a bitmap of valid downlink windows and a scaling factor governing monitor frequency. These broadcast elements are encoded compactly to minimize overhead and are repeated with sufficient periodicity and transport block size, optionally adjusted per coverage class based on the SI_AdaptationPolicy. Once broadcast, the RAN schedules the actual SI and control transmissions in accordance with the updated anchor timing, ensuring that the corresponding SI instances or NPDCCH messages are physically transmitted only in subframes that have been advertised as valid downlink opportunities. Devices that have decoded the broadcast descriptor use the included offset and sequence information to align their monitoring and decoding logic accordingly, thereby achieving robust SI reception and energy-efficient control tracking even in fragmented TDD environments with dynamic DL/UL subframe availability.

In an additional embodiment, the RAN node encodes the identification of postponed system information (SI) anchors using a compact signaling structure known as the SI-PostponeDescriptor, and includes this descriptor in one or more broadcast channels that are reliably decodable by narrowband Internet of Things (NB-IoT) devices. The SI-PostponeDescriptor is structured to efficiently convey, for each affected SI type, an original anchor index, a signed postponeOffset representing the alternative subframe relative to the original, and a short continuity sequence number (siSeq) used by devices to detect duplicate transmissions and suppress redundant processing.

To ensure wide compatibility and early accessibility during the device acquisition and attach process, the descriptor may be embedded in the Master Information Block (MIB), which is broadcast with high repetition and robustness, particularly during satellite timing intervals suitable for deep-coverage devices. Alternatively, when the descriptor pertains to multiple or frequently updated SI types, it may be included in one of the System Information Blocks (SIBs), such as SIB1 or a newly defined dedicated SIB that aggregates postponement data for multiple services.

In some configurations, the RAN may define a short periodic SIB with a compact payload specifically for conveying postponed anchor notifications on a recurring basis, using a lightweight encoding that can be parsed quickly by devices operating under tight power constraints. This short SIB may have a dedicated periodicity (e.g., every 80 ms or 160 ms) and remain active until a ‘stability flag’ indicates that postponements are no longer expected to change. The inclusion of the SI-PostponeDescriptor in one or more of these channels ensures that devices receive deterministic and timely updates regarding modified SI transmission timing, even when operating in fragmented downlink conditions caused by TDD frame mapping in satellite environments.

Therefore, the SI-Postponement Descriptor included in a broadcast message from the RAN node comprises, for each affected system information (SI) type, an explicit mapping from one or more original anchor indices to corresponding postponed offsets, along with a continuity identifier that allows devices to distinguish between new and previously decoded transmissions. Each original anchor index corresponds to a nominal subframe number or timing reference as defined by the legacy scheduling configuration for the SI type, and the RAN calculates a signed postponeOffset that identifies the subframe offset—positive or negative—relative to the original anchor at which the postponed SI instance will now be transmitted.

Such mapping enables devices to precisely realign their monitoring schedules without ambiguity, even when multiple SI types are impacted within a given TDD frame cycle. To further enhance robustness and minimize redundant processing, the descriptor includes a short continuity sequence identifier, such as a 4-bit siSeq value, that increments with each unique SI transmission. Upon receiving a postponed SI message, a device compares the siSeq value against its locally stored record and, if the value has already been processed, suppresses decoding and avoids energy-expensive reprocessing. This mechanism ensures that repeated SI transmissions (e.g., due to repetition or fallback scheduling) do not trigger unnecessary state transitions or false reception events in the UE. The combined use of anchor-offset mapping and continuity identifiers within the SI-Postponement Descriptor allows the system to support reliable SI delivery in fragmented TDD satellite environments while preserving energy efficiency and synchronization at the device side.

The method further comprises determining that no suitable downlink subframe is available within the current system information (SI) delivery window to accommodate a postponed SI transmission and, as a result, selecting a postponed anchor in a subsequent SI delivery window for reliable delivery. The radio access network (RAN) node evaluates all candidate downlink subframes within the active SI window, considering not only the validity of the subframe for downlink transmission under the configured TDD frame pattern, but also constraints such as required repetition spacing, transport block size, modulation/coding robustness, and guard period alignment. If no subframe satisfies these constraints for a given SI instance, the RAN defers the anchor selection to the next SI delivery window and designates a postponed anchor accordingly.

This inter-window postponement is then encoded into the broadcast signaling using a special indicator, such as a negative or reserved postponeOffset value or an explicit window offset flag, to unambiguously notify devices that the SI transmission has been deferred to a future repetition interval. Devices that receive this information are thus able to suppress their monitoring activity for the current window and realign their SI decoding expectations to the subsequent window, thereby avoiding unnecessary wake-ups and false decode attempts. This deferred scheduling logic is particularly critical in satellite-based TDD environments where fragmented downlink availability and extended propagation delays may intermittently block SI delivery windows, and where certain SI types-such as SIB1 or emergency-related SIBs-require deterministic delivery behavior governed by a service-level contract. The RAN may also internally log such deferrals and trigger escalation procedures, such as increased repetition or boosted transmission in the next window, to ensure continuity and compliance with configured delivery guarantees.

Additionally, the method further comprises maintaining and broadcasting a system information (SI) adaptation policy that maps wireless device coverage classes to corresponding SI transmission parameters, enabling the radio access network (RAN) node to tailor broadcast behavior based on real-time or historical device reception conditions. The RAN classifies coverage into discrete categories—such as Class 0 through Class 3—based on received signal strength, signal quality, or reported channel metrics like RSRP and RSRQ, typically collected from compact coverage reports periodically transmitted by devices.

The SI adaptation policy associates each coverage class with a set of transmission control variables including the number of repetitions for each SI block, the transport block size (TBS) used for encoding the SI message, the modulation and coding scheme (MCS) applied, and the relative preference for specific downlink subframes or anchor locations within a given SI delivery window. For example, deep-coverage devices (e.g., Class 3) may require a repetition count of four or more, reduced TBS for enhanced robustness, and preference for subframes with larger guard intervals or minimal Doppler slope. This policy is encoded into a System Information Block (e.g., SIB1 or a dedicated SI_AdaptationPolicy SIB) and broadcast periodically to ensure all devices can determine the expected configuration based on their current coverage class.

When the RAN prepares SI scheduling, it consults the policy to determine how to construct each SI instance-selecting repetition count, coding format, and anchor placement accordingly- and updates the system information delivery map. By broadcasting this policy, the RAN enables UEs to predict the SI transmission behavior aligned with their own coverage condition, which improves decoding reliability, minimizes unnecessary monitoring attempts, and supports deterministic handling of postponed SI anchors in non-terrestrial TDD networks.

Selecting system information (SI) transmission parameters for a given coverage class may further involve the radio access network (RAN) node dynamically adjusting one or more aspects of the SI transmission strategy in order to ensure decodability across varying radio conditions, especially in satellite-based TDD configurations where link margins and downlink availability can vary widely.

Upon receiving a coverage report from a device indicating a weak signal condition—such as classification into coverage Class 2 or Class 3—the RAN consults a pre-configured SI_AdaptationPolicy that maps coverage classes to enhanced transmission behaviors. For devices in poor coverage, the RAN may increase the repetition count for the SI instance, thereby scheduling multiple redundant transmissions across different downlink subframes within the same delivery window to improve decoding probability. Additionally, the RAN may adjust the transport block size downward or switch to a more robust modulation and coding scheme (MCS) to lower the decoding threshold required by the device's physical layer. In scenarios where downlink subframes with favorable timing or low Doppler shift are available, the RAN may introduce an additional “boosted” anchor, which represents an opportunistic SI transmission placed in a subframe with superior reception characteristics, such as greater guard spacing or favorable satellite trajectory alignment. If downlink fragmentation or congestion prevents effective repetition or boosted scheduling within the current carrier, the RAN may relocate the SI transmission to an alternate anchor carrier, such as a dedicated broadcast carrier, and advertise the relocation using a carrier pointer field in the broadcast descriptor. These selection mechanisms are governed by escalation rules within the SI_DeliveryContract and may be activated when a guaranteed number of successful SI receptions (e.g., K of L windows) cannot be met for targeted coverage classes. This ensures that critical broadcast information such as SIB1 or emergency alerts remains accessible to even the most disadvantaged devices operating under extreme satellite link budgets.

Moreover, the disclosed method further comprises broadcasting, for at least one system information (SI) type, a service-level SI-delivery contract that defines a guaranteed delivery criterion using two integers, K and L, as well as a coverage-target parameter that identifies the set of devices to which the guarantee applies. The radio access network (RAN) node encodes this SI-delivery contract in a System Information Block (SIB), such as SIB1 or a dedicated SI_DeliveryContract SIB, wherein the value K represents the minimum number of successful SI transmissions that must be scheduled within any L successive SI delivery windows for devices classified in the specified coverage class or below (e.g., Class 0 to Class 2).

Such contractual approach provides a deterministic expectation to low-coverage or mission—critical devices-such as those operating under deep signal fade or emergency conditions—that the network will ensure periodic, decodable delivery of vital SI messages such as SIB1, SIB2, or emergency SIB types, even in fragmented or delayed non-terrestrial TDD environments. To uphold this delivery contract, the RAN scheduler continuously monitors the SI anchor placement relative to the current TDD downlink map and tallies projected SI opportunities within the next L windows.

If it determines that fewer than K valid anchors can be placed due to downlink subframe unavailability, coverage adaptation constraints, or guard period restrictions, the RAN initiates one or more escalation actions. These may include increasing the repetition count, inserting additional “boosted” SI instances in favorable subframes, selecting larger transport block sizes for robustness, or relocating the SI to an alternate broadcast carrier with better link characteristics. The escalation action is triggered proactively—typically at least two windows in advance—and reflected in the updated SI-PostponeDescriptor or adaptation policy so that devices can realign their monitoring behavior accordingly. In some cases, if the escalation is unsuccessful or infeasible due to resource limits, the RAN may additionally set a “contract breach” indicator in a broadcast flag, allowing devices and network management systems (NMS) to take corrective actions or trigger fallback procedures. This service-level SI-delivery contract framework ensures that SI reliability is maintained with measurable guarantees across dynamic coverage conditions in satellite-based NB-IoT deployments.

When the radio access network (RAN) node determines that a system information (SI) delivery contract is at risk of being violated—specifically, that fewer than the guaranteed K SI transmissions will be successfully placed within the next L successive SI windows for a targeted coverage class—it initiates escalation actions designed to restore contractual compliance by increasing the likelihood of successful SI decoding by affected devices. One such escalation action involves inserting additional SI transmissions into carefully selected downlink subframes that are deemed favorable based on their placement within the 90 ms TDD pattern, their distance from guard periods, or their stability with respect to Doppler variation. These extra transmissions may not follow the nominal SI anchor schedule but are clearly marked with continuity identifiers to enable device-side suppression of duplicates.

In another implementation, the RAN increases the repetition count for one or more SI instances, causing the same SI content to be transmitted multiple times within the same delivery window or across adjacent ones, thereby enhancing the probability of at least one instance being received and decoded by devices in poor coverage conditions. If neither subframe availability nor repetition adjustment alone is sufficient to meet the delivery guarantee, the RAN may relocate the SI transmission to an alternate carrier or anchor frequency, typically one with more favorable downlink characteristics such as reduced load, wider availability of downlink subframes, or higher effective radiated power.

This relocation is accompanied by signaling—either embedded in the SI-PostponeDescriptor or in a dedicated carrier pointer field within the broadcast configuration—that informs devices of the new anchor location, ensuring that they can follow the transmission despite the relocation. These escalation actions, whether taken individually or in combination, enable the RAN to proactively fulfill the promised K-of-L delivery objective under challenging satellite TDD conditions, maintaining service-level continuity for NB-IoT devices operating at the edge of coverage.

The method further comprises broadcasting a control-channel monitoring schedule that explicitly informs devices of the timing and frequency with which they are expected to monitor for downlink control information in a fragmented time-division duplex (TDD) environment. The radio access network (RAN) node computes a bitmap representing valid downlink windows within a repeating frame period—such as a 90 ms pattern divided into nine 10 ms frames—based on the determined downlink and uplink subframe allocation. Each bit in this bitmap corresponds to a specific downlink window or subframe, with a binary value indicating whether that subframe is available for control-channel transmission.

The RAN also associates a scaling factor with the control configuration, which specifies how often devices should activate their receiver to monitor the control channel. For example, a scaling factor of four instructs devices to wake and monitor every fourth valid control opportunity, thereby significantly reducing power consumption compared to continuous monitoring. This control-channel monitoring schedule, referred to as NPDCCHMonitorSchedule, is embedded into broadcast signaling such as the Master Information Block (MIB) or a System Information Block (SIB), ensuring that all devices can acquire it early in the connection process.

Once broadcast, the RAN aligns its control-channel transmissions, such as NPDCCH messages for scheduling grants or configuration changes, exclusively within the subframes identified as valid in the bitmap. By avoiding transmission attempts outside these advertised windows, the RAN prevents wasted device wakeups and ensures predictable control-channel availability, even in scenarios where downlink opportunities are irregularly spaced due to guard period placement, Doppler constraints, or satellite trajectory variations. The combination of a bitmap and scaling factor allows devices to intelligently adapt their monitoring patterns—waking only when control messages are guaranteed to occur—and thereby extends device battery life while maintaining reliable downlink control reception in non-terrestrial NB-IoT deployments.

The method further comprises broadcasting a guard-period descriptor that explicitly defines a temporal guard interval to be applied between downlink and uplink transmission boundaries, thereby preventing interference and ensuring timing integrity in a non-terrestrial time-division duplex (TDD) environment. The radio access network (RAN) node calculates the guard interval based on several deployment-specific factors, including satellite altitude and trajectory, propagation delay uncertainty, Doppler shift dynamics, and the timing advance characteristics of connected devices.

The computed guard period, typically expressed in milliseconds or subframe units, is encapsulated in a GuardPeriodDescriptor and broadcast as part of system information, such as within a Master Information Block (MIB) or a dedicated System Information Block (SIB). Devices that receive this broadcast apply the indicated guard interval when performing uplink transmission timing calculations, ensuring that uplink bursts do not overlap with preceding downlink transmissions, even under large timing variations associated with satellite links. Additionally, the method allows for individualized optimization of the guard interval based on device capability. When a device signals enhanced timing precision—such as the availability of GNSS synchronization, high-stability oscillators, or predictive delay compensation—the RAN can respond with dedicated RRC signaling that configures a per-device guard override, reducing the guard period to reclaim additional usable transmission time or, conversely, extending it if the device exhibits greater timing uncertainty.

This per-device customization enables the network to maximize spectral efficiency while maintaining reliable separation of uplink and downlink transmissions across a diverse device population. The guard-period descriptor may also include auxiliary fields, such as an effective timing advance offset or a Doppler margin index, which devices can use to further refine their transmission timing. By combining broadcast guard interval signaling with targeted per-device overrides, the system achieves robust coexistence between downlink and uplink transmissions, minimizes interference near TDD switching points, and accommodates heterogeneous device timing capabilities in satellite-based NB-IoT deployments.

In another embodiment, the method further comprises, when configuring a preconfigured uplink resource (PUR) or a protected uplink resource for a narrowband Internet of Things (NB-IoT) device, including a per-resource or per-device indication that deferred uplink transmission is permitted, thereby enabling flexible and reliable uplink behavior in fragmented TDD environments. During the RRC configuration stage, the radio access network (RAN) node may set a deferredTxAllowed parameter associated with a specific PUR or UL-SPS allocation, which informs the device whether it is permitted to assemble and store an uplink medium access control (MAC) protocol data unit (PDU) when the scheduled uplink occasion coincides with a subframe designated as non-uplink in the current frame structure.

If deferred transmission is allowed, the RAN expects that the device will continue to execute its normal data preparation procedure—assembling a MAC PDU, associating it with the appropriate HARQ process, and optionally tagging it with a deferred identifier—but will withhold physical layer transmission and instead buffer the PDU locally. The RAN further anticipates that the device will retain the buffered PDU until it either receives an explicit uplink grant, a consume-deferred control element, or a HARQ instruction referencing the deferred buffer, at which point the stored PDU is transmitted. This deferred transmission behavior is particularly beneficial in satellite-based TDD configurations where uplink opportunities are sparse or irregular, as it prevents data loss and avoids repeated scheduling attempts while still enabling timely transmission once a suitable uplink window arises. Moreover, by broadcasting or signaling the deferredTxAllowed indication at either a per-UE or per-resource granularity, the network retains fine-grained control over deferred buffer usage, ensuring that system resources are efficiently utilized and that devices with limited memory or battery capacity are not burdened with unnecessary buffering operations.

Thus, the per-resource or per-device indication that deferred uplink transmission is permitted further comprises detailed configuration parameters that govern how the device buffers, retains, and prioritizes deferred medium access control (MAC) protocol data units (PDUs) when scheduled uplink opportunities are unavailable. Specifically, the radio access network (RAN) node may signal a maximum number of deferred PDUs that may be buffered per hybrid automatic repeat request (HARQ) process, thereby limiting the amount of data a device can store pending future transmission.

This constraint prevents excessive memory usage on low-cost NB-IoT devices and enables the RAN to manage uplink resource allocation more predictably. The configuration may also include a defer-expiry timer value, which specifies the maximum dwell time a buffered PDU may remain stored before it must either be transmitted upon receipt of a grant or discarded if no such grant is issued. This timer ensures that deferred transmissions do not persist indefinitely, which could otherwise lead to outdated or stale data being sent after long delays. Additionally, the RAN may assign a deferred buffer priority level, which the device uses to order multiple pending transmissions and determine which PDUs should be consumed first when an uplink opportunity arises. For example, PDUs tagged with a higher priority may be scheduled ahead of lower-priority deferred data, ensuring that time-sensitive information is transmitted with minimal delay once a valid uplink window is available.

On the network side, the RAN performs admission control by monitoring aggregate deferred buffer usage across devices and HARQ processes, preventing overall system congestion and ensuring that total deferred traffic does not exceed available uplink capacity. This admission control mechanism may involve rejecting new deferred buffering attempts, adjusting per-UE quotas, or dynamically reducing defer-expiry timers under heavy load conditions. Together, these parameters enable fine-grained control over deferred uplink behavior, balancing energy efficiency and data reliability while maintaining predictable resource utilization in satellite-based NB-IoT deployments with fragmented uplink opportunities.

Accordingly, the method further comprises issuing an explicit uplink scheduling command that instructs a device to transmit a previously buffered deferred medium access control (MAC) protocol data unit (PDU) once a suitable uplink opportunity arises. After determining that a device has assembled and stored a PDU due to the absence of a valid uplink subframe during a scheduled transmission occasion, the radio access network (RAN) node monitors the availability of future uplink windows and overall system resource conditions. When an appropriate transmission opportunity is identified, the RAN generates and transmits either a standard uplink grant message or a dedicated MAC control element (CE) that references the specific deferred buffer through a unique identifier, such as a deferredTag, buffer index, or hybrid automatic repeat request (HARQ) process identifier associated with the stored PDU.

The explicit signaling serves as a deterministic trigger, prompting the device to retrieve the corresponding PDU from its local buffer and initiate physical transmission during the allocated uplink resources. The use of such targeted grants ensures precise coordination between the network and the device, avoiding unnecessary polling or continuous buffer checks while maintaining strict control over deferred data flow. Additionally, the explicit reference mechanism allows the RAN to selectively request transmission of high-priority deferred PDUs while leaving others buffered for later consumption or eventual discard if their defer-expiry timers elapse. This approach is particularly advantageous in non-terrestrial TDD deployments, where uplink opportunities may be sparse or unpredictably spaced, because it allows the network to flexibly manage deferred traffic and ensure that stored data is delivered efficiently without violating timing, QoS, or resource allocation constraints.

In another embodiment, the method further comprises collecting and exposing telemetry data that reflects the operational status of the system information (SI) delivery contract, thereby enabling both network operators and devices to verify compliance with the guaranteed delivery criteria. The radio access network (RAN) node maintains internal counters that track the number of actual SI transmissions successfully scheduled and transmitted toward fulfilling the K-of-L guarantee defined in the SI_DeliveryContract.

For each SI type covered by the contract, the RAN updates these counters on a per-window basis, incrementing them whenever a valid SI transmission occurs and resetting or rolling them over as successive SI windows progress. This telemetry enables the network to continuously assess whether the delivery trajectory remains on track or if there is a shortfall that may necessitate escalation actions such as repetition increases, anchor insertions, or carrier relocations. In scenarios where the scheduler determines that escalation options have been exhausted or cannot be applied due to resource limitations, regulatory constraints, or guard period conflicts, and the K-of-L requirement will not be met within the current service window, the RAN generates and disseminates a contract breach indicator.

This indicator can be broadcast as part of a system information block, included as a one-bit field in the SI_DeliveryContract SIB, or reported to higher-layer network management entities via an OAM or telemetry interface. Devices that receive the breach indicator can adjust their behavior accordingly, for example by invoking fallback SI monitoring strategies, prolonging paging cycles, or triggering a reattachment procedure if critical configuration data remains unavailable. By exposing this contract-level telemetry and breach signaling, the network ensures transparent service-level reporting, facilitates troubleshooting and adaptive planning at the device and network layers, and enables proactive mitigation strategies in environments where TDD frame fragmentation or satellite dynamics make strict SI delivery guarantees challenging to maintain.

Selecting alternative downlink anchors for postponed system information (SI) delivery comprises the radio access network (RAN) node dynamically evaluating and choosing among multiple transmission locations, which may include subframes on the same carrier, subframes on an alternate carrier within the same cell, or anchor resources hosted on a neighboring cell's carrier. The selection process begins by analyzing the availability of valid downlink subframes within the configured TDD frame pattern on the serving carrier.

If sufficient downlink opportunities exist, the RAN may simply reschedule the SI transmission to a new anchor within the same carrier, minimizing signaling overhead and preserving device context. However, if downlink availability is limited or signal quality is suboptimal on the primary carrier—such as during congestion, deep fading, or extended guard period occupation—the RAN may select an alternate carrier within the same cell, such as a supplemental narrowband channel or a dedicated broadcast carrier, that offers improved subframe continuity or link robustness.

In another scenario, particularly when the current serving cell cannot satisfy SI delivery constraints, the RAN may relocate the SI anchor to a cooperating cell within the same tracking area or satellite footprint, leveraging inter-cell coordination to ensure continuity of broadcast information. In all such cases, the RAN augments the broadcast signaling—specifically, the SI-PostponeDescriptor or a dedicated cross-carrier pointer field—with explicit metadata indicating whether the SI transmission will occur on a different carrier or in a different cell, and includes addressing information such as a physical cell identifier, anchor carrier frequency, or synchronization signal block (SSB) index. This metadata allows devices to seamlessly locate and decode the relocated SI instance without requiring a full reattachment procedure or blind cell search. By enabling flexible anchor selection across carriers and cells, and by providing explicit broadcast-level guidance to assist device tracking, the system ensures consistent SI delivery under dynamically changing spectral, timing, or coverage conditions that commonly occur in non-terrestrial NB-IoT deployments.

On the device/UE/WTRU side, a method performed by a wireless device configured to operate in a time-division duplex (TDD) network comprises adapting its reception and transmission behaviors based on dynamic broadcast configuration and postponement signaling provided by the radio access network (RAN).

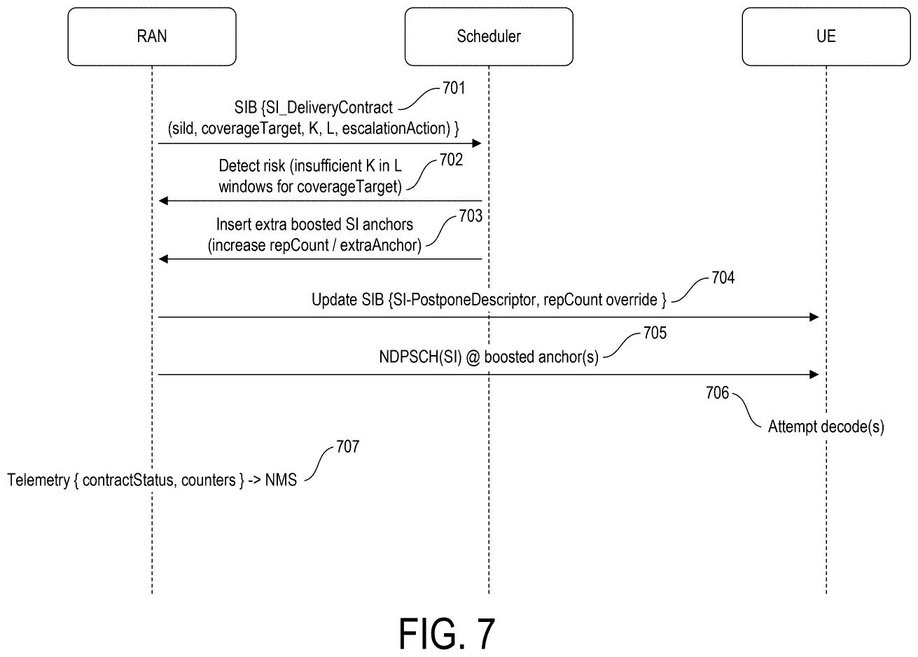

FIG. 7 illustrates a scheduler-driven flow for contractual delivery of system information (SI) under a K-of-L guarantee. At 701, the radio access network (RAN) broadcasts an SI_DeliveryContract identifying the applicable coverageTarget and the guarantee parameters K and L, together with an escalationAction policy selectable by the scheduler. This contract enables devices to understand that, within any L successive SI windows, at least K successful SI opportunities will be provisioned for the indicated coverage class, and it equips the scheduler with a policy handle for recovery when risk is detected. At 702, the scheduler evaluates projected SI opportunities against the current TDD map and ongoing guard/availability constraints and detects risk that fewer than K valid anchors can be placed within the next L windows for the specified coverage class.

The risk evaluation is performed continuously using per-type counters and window tallies so that corrective action can be initiated before the contract is missed. Responsive to risk, the scheduler executes an escalation policy. At 703, it inserts extra boosted SI anchors and/or increases the repetition count to raise the likelihood of at least one decodable SI instance within the remaining opportunities of the window; these insertions are placed on favorable downlink subframes and may deviate from the nominal anchor cadence when necessary. At 704, the RAN updates the SIB to reflect the changed plan (e.g., an updated SI-PostponeDescriptor and a repCount override) so that devices align monitoring to the corrected anchors without requiring re-attachment or blind search. The revised broadcast state carries the explicit adaptation so UEs can suppress duplicates and follow relocated or repeated SI instances deterministically. At 705, the NDPSCH (SI) transmissions occur on the boosted anchors per the escalated plan, while the UE at 706 attempts decode(s) according to the updated broadcast guidance. When extra transmissions are used, continuity identifiers allow device-side duplicate suppression while preserving the increased success probability of the window. At 707, the scheduler reports telemetry {contractStatus, counters} toward network management to expose K-of-L progress and any applied escalation. If escalation cannot restore compliance (e.g., due to resource limits), a breach indicator may be broadcast so devices can adopt fallback monitoring or recovery procedures.

Upon receiving the corresponding trigger, the device transmits the previously buffered PDU during a valid uplink opportunity. This coordinated procedure ensures that the device maintains reliable access to critical broadcast information and can flexibly handle sporadic uplink availability without data loss, retransmission storms, or unnecessary power consumption, which is particularly essential for low-cost, battery-constrained NB-IoT devices operating in satellite-based TDD environments.

The received broadcast or dedicated information that identifies alternative downlink subframes for postponed system information (SI) delivery further includes a continuity identifier associated with each SI instance, and the wireless device leverages this identifier to intelligently manage decoding operations and suppress redundant processing. The continuity identifier, such as a short sequence number (siSeq) that increments modulo a fixed range (e.g., 0-15), is generated and updated by the radio access network (RAN) each time a new SI transmission is prepared, regardless of whether the transmission occurs at the nominal anchor or a postponed one.

When the device successfully decodes an SI instance, it stores the corresponding continuity identifier in local memory and uses it as a reference during subsequent monitoring cycles. If the device later receives another SI transmission with the same continuity identifier, it recognizes that the transmission is either a repetition of the previously received instance or a replay due to postponed scheduling and therefore suppresses duplicate processing. This behavior significantly reduces unnecessary decoding attempts, conserves processing energy, and avoids confusion in higher-layer procedures that could otherwise arise from repeated handling of the same SI content.

Furthermore, because the continuity identifier is linked to the specific SI type and its sequence evolution, the device can distinguish between fresh system information updates and retransmissions caused by postponed anchors or increased repetition due to a delivery contract escalation. This mechanism ensures deterministic SI processing and enables devices to focus their reception resources only on new or updated broadcast information, a capability that is particularly critical in satellite-based TDD networks where repeated SI transmissions may occur frequently due to fragmented downlink availability and aggressive repetition strategies for deep-coverage scenarios.

This, in one exemplary embodiment, the method further comprises applying a received control-channel monitoring bitmap and an associated scaling factor to optimize the wireless device's monitoring behavior and significantly reduce power consumption in a non-terrestrial time-division duplex (TDD) deployment. Upon decoding broadcast system information, the device obtains a control-channel monitoring schedule, such as an NPDCCHMonitorSchedule, that explicitly indicates which subframes within a repeating frame period are valid for downlink control signaling.

Each bit of this bitmap corresponds to a subframe or monitoring window and indicates whether that interval is expected to carry NPDCCH transmissions. The device uses this bitmap in combination with a scaling factor, also received from the network, that dictates the frequency of monitoring relative to the nominal configuration. For example, if a scaling factor of four is signaled, the device monitors only one in every four valid control windows identified in the bitmap. By combining bitmap filtering with scaled periodicity, the device activates its receiver only during the subset of occasions where downlink control information is actually scheduled, while remaining in a low-power state during other intervals. This selective wake-up strategy significantly reduces battery drain without compromising reliability of control reception, especially in satellite-based NB-IoT systems where valid downlink windows are sparse and irregular due to guard periods and propagation-induced scheduling gaps.

When the device is configured for deferred uplink transmission and a scheduled uplink opportunity falls within a subframe designated as non-uplink in the TDD frame structure, it assembles a medium access control (MAC) protocol data unit (PDU) and stores it locally with a deferred buffer tag and a hybrid automatic repeat request (HARQ) process identifier. Simultaneously, the device starts a local defer-expiry timer set to a value provided by the network, which defines the maximum dwell time the buffered PDU may remain pending before being either transmitted or discarded.

The device remains in a passive state until it receives an explicit uplink grant or a MAC control element referencing the deferred buffer tag or HARQ identifier, at which point it retrieves the corresponding PDU and transmits it during the allocated uplink window. If the defer-expiry timer elapses before any such grant is received, the device discards the buffered PDU to prevent transmission of stale data and may optionally include a discard notification in a subsequent diagnostic or telemetry report sent to the network. This behavior ensures that deferred uplink data is transmitted in a controlled and timely manner without risking buffer overflow or outdated data delivery, while also providing the network with visibility into deferred traffic handling performance. Together, the selective control-channel monitoring mechanism and the deferred buffering procedure enable highly energy-efficient, reliable, and coordinated operation of NB-IoT devices in fragmented satellite TDD networks.

Additionally, the method further comprises applying a broadcast guard-period value received from the radio access network (RAN) to the device's uplink timing computations in order to avoid transmitting during guard intervals and thereby prevent interference at the downlink-uplink transition. The device decodes a GuardPeriodDescriptor included in system information, which specifies a temporal separation interval that must be observed between the end of downlink transmissions and the beginning of uplink transmissions. This guard interval is incorporated into the device's transmission scheduling algorithms such that no uplink transmission is initiated within the protected time window, even if a configured uplink occasion appears to be available.

This mechanism ensures that uplink bursts do not collide with delayed downlink signals, which is especially important in satellite-based TDD environments where large propagation delays and Doppler variations can significantly shift the timing boundaries. Furthermore, when the device is equipped with enhanced timing capabilities—such as high-precision GNSS synchronization, advanced oscillator stability, or predictive timing models—it may transmit a guard-override request to the RAN indicating its ability to operate with a reduced guard interval. If the network grants the request via dedicated signaling, the device applies a per-device guard override, using a shorter guard period to reclaim additional usable uplink transmission time while still maintaining safe separation from downlink transmissions. This adaptive approach allows the system to maximize spectral efficiency without compromising transmission integrity across heterogeneous device capabilities.

In an additional embodiment, when a broadcast SI-PostponeDescriptor is not present in the received system information or is detected to be stale—such as when the continuity identifier has not changed for an extended period or the postponeOffset is outdated relative to the current TDD mapping—the device initiates a deterministic fallback procedure to ensure continued access to critical broadcast information. Under this procedure, the device applies a predefined fallback rule, such as monitoring the next available one or more downlink subframes within the system information (SI) delivery window, regardless of whether they were explicitly signaled. This behavior guarantees that the device maintains at least a baseline opportunity to receive and decode SI, even in scenarios where broadcast signaling has been lost, delayed, or corrupted. After executing the fallback procedure, the device records that the fallback mode was triggered and includes this information in a subsequent coverage report transmitted to the network, for example by setting a fallbackUsed flag alongside the reported coverage class and last successfully decoded SI continuity identifier. The RAN can use this feedback to diagnose potential broadcast reliability issues, trigger additional SI repetitions, or initiate corrective actions in future scheduling cycles. This combination of deterministic fallback monitoring and explicit reporting enhances robustness and ensures reliable system operation in non-terrestrial TDD environments where link dynamics or signaling disruptions may occasionally interrupt the normal SI postponement signaling process.

Deferred SSB and/or NB-IoT NPSS/NSSS due to NTN beam availability restrictions.

Furthermore, in an implementation of the deferred transmission solution, the RAN node may extend the anchor-relocation procedure beyond SI to synchronization transmissions, and determines that one or more synchronization anchors, comprising NR Synchronization Signal Blocks (SSBs) or, in NB-IoT, NPSS/NSSS and NPBCH bursts, would nominally occur in subframes not available for downlink under the repeating TDD pattern; thus, the RAN selects alternative downlink subframes within the applicable synchronization burst window, prioritizes candidates by guard distance and Doppler favorability, and encodes a compact synchronization-anchor descriptor that maps the nominal synchronization index (e.g., ssbIndex or NPSS/NSSS instance) to a signed postpone offset and includes a short continuity identifier to suppress duplicate processing.

Accordingly, descriptor is broadcast using existing broadcast channels appropriate to the RAT (for NR, by updating ssb-PositionsInBurst/periodicity fields and adding a compact relocation container carried in SIB1 or a short periodic SIB; for NB-IoT, by including a relocation container alongside MIB/SIB parameters governing NPSS/NSSS/NPBCH), and the RAN schedules the relocated synchronization bursts only in the advertised downlink-valid windows. A wireless device that decodes the descriptor constrains its synchronization search to the indicated postponed windows, applies the continuity identifier to ignore repeated bursts, and updates its timing and beam selection accordingly; for beam-swept NR cells, the descriptor may additionally identify a beam or burst-set index so that devices can reattempt detection on the correct swept opportunity without blind scanning.

In another embodiment, a service-level delivery contract is extended to synchronization transmissions, wherein integers K and L and a coverage target are broadcast such that at least K synchronization bursts (SSB or NPSS/NSSS) are scheduled within any L successive burst windows for devices in the target coverage class; when projected placement under the current DL/UL map would fail to meet the guarantee, the RAN escalates by inserting additional synchronization bursts in favorable downlink subframes, temporarily elevating transmission robustness, or relocating the synchronization anchor to an alternate carrier, and sets a breach indicator if escalation cannot be completed within a service window so that devices may apply deterministic fallback search rules while preserving energy.

In a further embodiment, a device receiving the synchronization-anchor descriptor limits SSB or NPSS/NSSS/NPBCH detection attempts to postponed downlink opportunities indicated by a bitmap and offset, scales its synchronization search periodicity using a broadcast monitor scaling factor to avoid waking during invalid windows, and records the last successfully decoded synchronization continuity identifier; upon a subsequent relocation or repetition with the same identifier the device suppresses duplicate baseband processing, and upon detecting descriptor staleness the device applies a deterministic fallback rule to monitor the next available downlink subframe(s) within the synchronization window and reports the fallback use in a compact coverage/synchronization report.

Non-IoT deferred transmissions.

In an additional embodiment applicable to non-IoT NR user equipment, the gNB may derive a repeating NTN TDD map and determines that nominal control anchors configured for eMBB or RedCap UEs, specifically PDCCH monitoring occasions bound to one or more search spaces within CORESETs, overlap subframes that are not downlink-valid; the gNB selects alternative downlink-valid monitoring occasions within the same control window, updates a compact Control-Anchor Relocation Descriptor that maps the nominal search-space occasion index to a signed offset with a continuity identifier, and broadcasts or unicasts this descriptor via SIB1 or dedicated RRC reconfiguration. Each affected UE applies the descriptor to align PDCCH monitoring to the relocated occasions and suppresses duplicates by comparing the continuity identifier, thereby avoiding wasted wake-ups and missed grants under fragmented DL availability while preserving 3GPP NR control semantics.

In another embodiment, paging for NR UEs is adapted to fragmented DL by relocating paging occasions when a UE's configured PO falls inside a non-DL subframe of the NTN TDD pattern. The gNB computes a Paging Relocation Descriptor that identifies, for each TA or RAN paging group, a bitmap of valid DL windows and a signed offset from the nominal PO, optionally paired with a K-of-L paging-delivery contract for coverage classes defined by the network. The descriptor is broadcast so that idle and RRC-INACTIVE UEs wake only on relocated paging occasions; where the scheduler projects that K successes cannot be met within L cycles, escalation is triggered by inserting additional paging transmissions or temporarily boosting robustness on favorable DL windows, with a breach flag signaled if escalation cannot be completed.

In a further embodiment, NR synchronization and measurement anchoring for non-IoT UEs is made relocation-aware. When SSB bursts, CSI-RS measurement resources, or SSB measurement (i.e., SMTC) windows would nominally fall into non-DL portions of the 90 ms NTN map, the gNB selects alternative downlink subframes within the applicable burst/SMTC window and signals a Synchronization/Measurement Relocation Container that includes per-SSB or per-CSI-RS indices, signed offsets, and a short continuity number. UEs constrain SSB/CSI-RS detection and measurement to the relocated windows, maintain beam/SSB association, and suppress duplicate processing for repeated bursts carrying the same continuity value, while applying a deterministic fallback rule on descriptor staleness and reporting fallback usage in a compact measurement report.

In yet another embodiment, uplink behavior for non-IoT NR UEs using configured grant PUSCH (CG Type 1/Type 2) and periodic PUCCH is extended with deferred-UL semantics. If a CG-PUSCH or PUCCH HARQ-ACK occasion lands in a non-UL subframe, and the per-UE or per-resource configuration permits deferral, the UE assembles the transport block or ACK/NACK bundle, tags it with a deferred identifier bound to the HARQ process, starts a defer-expiry timer, and buffers without transmission; the gNB later issues a DCI or MAC CE referencing the deferred identifier to cause transmission in a valid UL window, or purges upon expiry. Admission control caps aggregate deferred buffers across UEs to protect capacity while preserving reliability for bursty NTN UL availability.

In an additional embodiment relevant to NR multicast/broadcast services and emergency warning delivery to non-IoT devices, the gNB applies the same relocation and contractual guarantees to MBS or public warning messages whose scheduled DL slots are invalid under the NTN TDD map. The gNB relocates the broadcast anchor within the service window, optionally to a cross-carrier anchor with better DL density, signals the relocation in a compact container with continuity information, and enforces a K-of-L delivery contract for targeted coverage classes, escalating by inserting extra broadcast instances or increasing robustness when projected opportunities fall short.

DVB S and/or QV service links may be extended in embodiments.

Furthermore, in an additional embodiment applicable to DVB-S/S2/S2X and/or QV forward links, a satellite gateway determines that nominal emission instants for periodic program and service information tables-such as PAT/PMT/NIT/SDT/EIT or operator ESG sections-would coincide with downlink-invalid windows induced by a beam-hop or NTN TDD pattern at the terminal footprint, selects alternative emission instants within the applicable table repetition window, and emits a compact anchor-relocation descriptor carried in a private section or private descriptor conformant to DVB-SI syntax. The descriptor maps nominal table emission indices to signed postpone offsets and includes a short continuity identifier distinct from the DVB version_number so terminals can suppress duplicate processing of repeated sections while still honoring version changes. A bitmap of valid downlink windows and an optional monitor-scaling factor may be embedded in the same private section to gate terminal wakeups to only those time-slices where PSI/SI is guaranteed to appear, and a K-of-L delivery contract for critical tables (e.g., NIT/SDT) may be broadcast so the gateway escalates by inserting boosted repeats or relocating the table to a more favorable BBFRAME window when projected opportunities fall short.

In another embodiment targeting DVB-RCS2 return channels, when a terminal's assigned capacity (e.g., within a capacity assignment message for CRA/VBDC/ACA) resolves to a timeslot that overlaps a non-uplink window under the current satellite timing/guard configuration, the terminal assembles a MAC PDU, tags it with a deferred identifier bound to its RCST queue class, starts a defer-expiry timer, and buffers without physical transmission; the network control center later issues an explicit consume-deferred instruction by referencing the deferred identifier in a subsequent capacity assignment to cause transmission in a valid return-link burst, with admission control applied across RCSTs to cap aggregate deferred buffers. If the timer expires first, the terminal discards the PDU and may report the discard in a lightweight telemetry field piggybacked on the next successful burst.

Accordingly, in a generalized embodiment for non-3GPP satellite broadcast networks that employ periodic signaling artifacts, a network node determines downlink-valid windows over a repeating period, detects that nominal periodic artifacts (tables, beacons, announcements) would occur in invalid windows, selects alternative emission instants within the artifact's delivery window, and signals a compact relocation descriptor with offsets and a continuity identifier using a standard-compliant private container for that protocol; receivers restrict monitoring to relocated windows with optional scaling, suppress duplicates via the continuity identifier, and report fallback or breach when descriptors are stale or when K-of-L delivery could not be met.

Embodiments herein provide for on-demand reduced-rate SI capture.

Additionally, the RAN maintains and broadcasts an SI_OnDemandPolicy that designates a subset of system information types as on-demand eligible and specifies a minimum periodic baseline for each such SI, wherein the baseline ensures at least a low-rate K-of-L floor while the remaining instances are served reactively upon UE request; the RAN collects compact CoverageReports and lastSiSeq identifiers, applies admission control using a token-bucket per cell and per UE class, and, when an eligible request is accepted, selects alternative downlink subframes within the current or subsequent SI window consistent with the NPDCCHMonitorSchedule and GuardPeriodDescriptor, encodes any relocation in the SI-PostponeDescriptor with a fresh continuity identifier, and transmits the requested SI instance as a shared multicast where possible or as a dedicated burst otherwise, thereby reducing steady-state SI overhead while preserving deterministic delivery for coverage-challenged devices.

In another embodiment, a wireless device receiving the SI_OnDemandPolicy determines that a needed SI type is on-demand eligible and, if its locally cached continuity identifier is stale, composes a compact SI_Request control element containing the SI type mask, lastSiSeq, and an optional integrity hash of the cached SI; if the next configured UL occasion falls in a non-uplink subframe and deferred transmission is permitted, the device buffers the request with a deferred tag and HARQ identifier and starts a defer-expiry timer, otherwise transmitting immediately; upon grant consumption the device listens only at the relocated downlink anchors signaled by the SI-PostponeDescriptor, suppresses duplicates using the continuity identifier, and, if the request is throttled by the network, applies a backoff indicated in the policy to avoid request storms while maintaining energy efficiency.

In an additional embodiment, when multiple devices request the same on-demand SI within a collection interval, the RAN may aggregates requests and issues a lightweight paging-style notification or NPDCCH indication that points to a forthcoming relocated SI anchor identified in the SI-PostponeDescriptor, devices in the group wake only for the announced anchor, decode the shared instance carrying a fresh continuity identifier, and suppress retries, allowing the network to replace numerous unicast responses with a single multicast while maintaining precise energy-aligned wakeups.

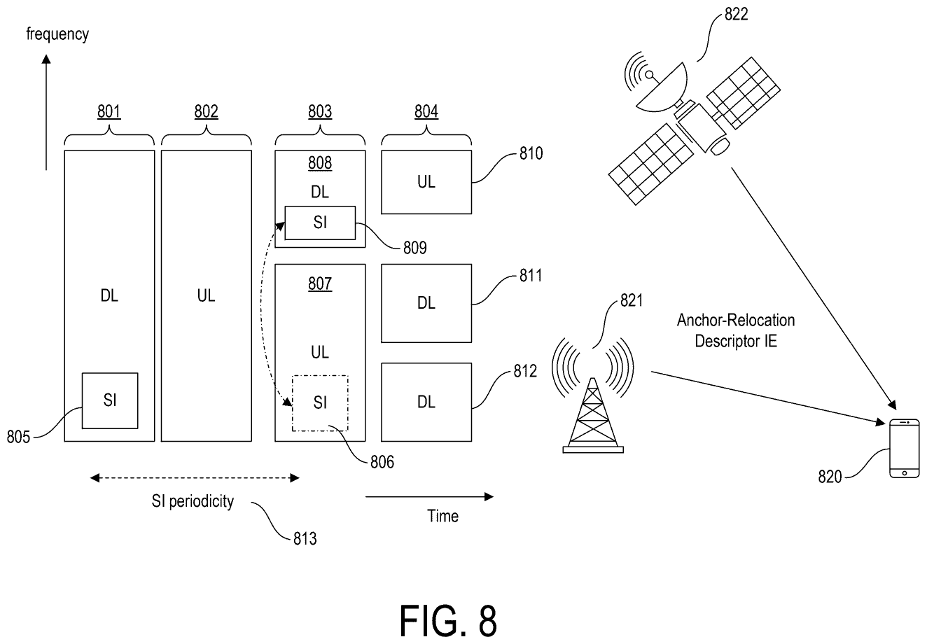

As shown by FIG. 8, in one embodiment, the RAN node determines, for a repeating period comprising subframes and SBFD symbols with concurrent downlink and uplink subbands, a set of downlink-valid time-frequency tiles, identifies that nominal SI or control anchors fall into tiles that are downlink-invalid (e.g., UL-only sub-bands within an SBFD symbol), and selects alternative downlink tiles within the SI delivery window that satisfy guard-distance and Doppler constraints; the RAN encodes a compact Anchor-Relocation Descriptor that maps the nominal anchor index to a signed time-frequency offset and includes a continuity identifier, and broadcasts the descriptor so devices monitor only the relocated tiles and suppress duplicates carrying the same continuity value.

FIG. 8 illustrates a RAN node that determines, for a repeating period comprising subframes and SBFD symbols with concurrent downlink and uplink subbands, a set of downlink-valid time-frequency tiles, identifies that nominal SI or control anchors fall into tiles that are downlink-invalid (e.g., UL-only sub-bands within an SBFD symbol), and selects alternative downlink tiles within the SI delivery window that satisfy guard-distance and Doppler constraints.

Specifically, FIG. 8 shows, in time, a DL time interval 801, UL time interval 802, first SBFD time interval 803 and second SBFD interval 804. SI may be provided in DL time interval 801. The SI periodicity 813 may indicate that another SI 806 will occur in UL portion 807 of first SBFD time interval 803. Because SI 806 is scheduled to occur in a an uplink time-frequency tile 807, SI 806 may be moved to occur 809 in DL portion 808 of third SBFD time interval 803. Fourth SBFD time interval 804 may comprise a different SBFD pattern than third SBFD time interval 803, for example, fourth SBFD time interval may have UL 810, DL 811 and DL 812.

The relocation of SI 809 is due to reception of an anchor relocation descriptor IE by a WTRU 820 from one of a terrestrial base station 821 or a satellite station 822.

In another embodiment, the RAN broadcasts a control-monitor schedule that specifies a bitmap over time and sub-band frequency indices for each SBFD symbol in the repeating period together with a scaling factor; devices gate NPDCCH (or NPDCCH-equivalent) monitoring to occurrences where both the time bit and sub-band bit are asserted and apply the scaling factor to skip fractions of otherwise valid occasions, thereby avoiding wakeups in DL-invalid sub-bands while preserving control reception under SBFD operation.

In a further embodiment, when a configured uplink resource resolves to a tile that is UL-invalid due to SBFD sub-banding in the scheduled symbol, and a per-resource deferred-UL indication is present, the device assembles a MAC PDU, tags it with a deferred identifier bound to the HARQ process and intended UL-subband, starts a defer-expiry timer, and buffers without transmission; the RAN later issues an explicit grant or MAC CE that references the deferred identifier and the target UL-subband, causing transmission in a valid SBFD UL tile; upon expiry, the device discards the PDU and may report the discard in a diagnostic report.

In yet another embodiment, the RAN broadcasts a Guard-Period Descriptor that includes both a time guard between DL/UL boundaries and a frequency-selective guard mask for SBFD symbols identifying subband-edge protection; devices apply the broadcast guard to uplink timing and spectral placement, and timing-capable devices may request a per-UE guard override that tightens either the temporal guard or the frequency mask, which the RAN grants by dedicated signaling to reclaim usable SBFD UL bandwidth without violating coexistence constraints.

A method performed by a radio access network (RAN) node for providing service to narrowband Internet of Things devices in a time-division duplex (TDD) network may comprise: determining, for a repeating frame period, which subframes are available for downlink and which subframes are available for uplink, and, where sub-band full-duplex (SBFD) is configured, which time-frequency regions within downlink symbols are downlink-valid; determining that one or more devices are configured to expect system information (SI) or control anchors at nominal subframe locations that fall within subframes not available for downlink; selecting alternative downlink subframe(s) within a defined SI delivery window for transmission of the system information or control anchors, and, where sub-band full-duplex (SBFD) is configured, selecting alternative downlink time-frequency region(s) within the SI window; and broadcasting, to the devices, information identifying the selected alternative downlink subframe(s) and scheduling transmissions in accordance with the selected alternative downlink subframe(s).

Broadcasting the information may comprise including a compact SI-postponement descriptor in a broadcast channel, and wherein the compact descriptor is carried in at least one of: (a) a Master Information Block (MIB), (b) a System Information Block (SIB), or (c) a newly-defined short periodic SIB dedicated to postponed anchor notifications.

The compact SI-postponement descriptor includes, for each affected SI type, a mapping from original anchor(s) to postponed offset(s), and a continuity identifier that permits devices to detect and ignore duplicate or replayed SI transmissions.

When no suitable alternative downlink subframe exists within the current SI delivery window, selecting a postponed anchor in a subsequent SI delivery window and indicating in the broadcast information that the postponed anchor is in the subsequent window.

Maintaining and broadcasting an SI adaptation policy that maps device coverage classes to SI transmission parameters, wherein the SI transmission parameters include one or more of: repetition count, transport block size selection, modulation/coding selection, or preference for anchor placement.

Selecting SI transmission parameters for a given coverage class comprises performing at least one of: increasing the repetition count for the SI, increasing the transport block size or robustness, scheduling an additional boosted SI anchor in a favorable downlink subframe, or relocating the SI to an alternate anchor carrier.

Broadcasting, for at least one SI type, a service-level SI-delivery contract that defines integers K and L and a coverage-target such that the RAN guarantees that at least K SI transmissions will be scheduled within any L successive SI windows for devices in the coverage-target, and performing escalation actions when the RAN determines the scheduled anchors would otherwise fail to meet the defined guarantee.

The escalation actions include at least one of: inserting additional SI transmissions in selected downlink subframes, increasing the repetition count for one or more SI instances, or relocating the SI to an alternate carrier or anchor with more favorable downlink opportunities.

Broadcasting a control-channel monitoring schedule that, for a control configuration, specifies a bitmap of valid downlink windows within the repeating frame period and a scaling factor indicating how often the device should monitor the control configuration, and transmitting control-channel messages only in the broadcasted valid downlink windows.

broadcasting a guard-period descriptor indicating a guard interval to be applied between downlink and uplink boundaries and, in response to a device capability request, configuring a per-device guard override via dedicated signaling to reduce or increase the guard interval for that device.

when configuring a preconfigured uplink resource or protected uplink resource, including a per-resource or per-UE indication that deferred uplink transmission is permitted; and, if deferred uplink is permitted, expecting that a device may assemble and buffer an uplink MAC PDU when the scheduled uplink occasion falls in a non-uplink subframe.

The per-resource or per-UE indication includes one or more of: a maximum number of buffered deferred PDUs per HARQ process, a defer-expiry timer value indicating a maximum buffered dwell time, and a deferred buffer priority, and wherein the RAN enforces admission control based on aggregated deferred buffer usage.

Issuing an explicit uplink grant or a MAC control element that references a deferred buffer identifier or HARQ identifier to cause a device to transmit a previously buffered deferred PDU.

Collecting and exposing telemetry indicating contract status including counters of actual SI transmissions placed toward K in each L-window, and broadcasting or reporting a contract breach indicator if escalation could not be completed within a service window.

Selecting alternative downlink anchors comprises selecting anchors on the same carrier, on an alternate carrier within the same cell, or on an anchor carrier in another cell, and wherein the broadcast information identifies whether the SI will be transmitted on a different carrier and provides addressing information to enable devices to locate the anchor.

A method performed by a wireless device configured to operate in a TDD network, the method comprising: receiving broadcast configuration information that indicates which subframes in a repeating frame period are available for downlink and which subframes are available for uplink; receiving broadcast or dedicated information that identifies alternative downlink subframe(s) for system information whose originally scheduled anchor(s) fall in non-downlink subframe(s); monitoring for and attempting to decode system information at the identified alternative downlink subframe(s); and when an uplink occasion associated with a configured uplink resource falls in a non-uplink subframe and the configured uplink resource permits deferred transmission, assembling and buffering an uplink MAC protocol data unit and awaiting a subsequent grant referencing the buffered PDU for transmission.

The received information identifying alternative downlink subframe(s) comprises a continuity identifier for each SI instance, and wherein the device uses the continuity identifier to suppress duplicate processing of repeated SI transmissions.

Classifying local reception conditions into a coverage class, generating a compact coverage report that includes the coverage class and a last successfully decoded SI continuity identifier, and transmitting the compact coverage report to the network at attach or upon a threshold event.

Applying a received control-channel monitor bitmap and a scaling factor so as to wake only during scaled monitoring occurrences that fall within the valid downlink windows indicated by the bitmap.

When buffering a MAC PDU due to a non-uplink occasion the device stores the buffered PDU with an associated deferred buffer tag and HARQ identifier, starts a local defer-expiry timer set to a configured value, and upon receiving an explicit grant referencing the deferred buffer tag or HARQ identifier, transmits the buffered PDU; and if the defer-expiry timer expires prior to consumption, the device discards the buffered PDU and optionally reports the discard in a subsequent uplink diagnostic report.

Applying a broadcast guard-period value to uplink timing computations to avoid transmissions during guard intervals and, when the device has an enhanced timing capability, transmitting a guard-override request to the network and applying a per-device guard override if the network grants the request.

When a broadcast SI-postponement descriptor is not present or is detected to be stale, the device applies a deterministic fallback rule to monitor the next available downlink subframe(s) within the SI delivery window and indicates, in a subsequent coverage report, that a fallback was used.

A method and apparatus for supporting NB-IoT operation over TDD non-terrestrial networks are disclosed. A repeating frame pattern is determined and subframes are classified as downlink, uplink, or guard. SI and control anchors that fall in non-downlink subframes are identified and postponed to alternative downlink subframes within a defined SI window, with a compact SI-postponement descriptor carrying anchor offsets and a continuity identifier being broadcast in MIB/SIB or a short periodic SIB. An SI adaptation policy is maintained and broadcast to map coverage class to SI parameters, and an SI-delivery contract (K-of-L with a coverage target) is advertised and enforced via escalation actions, including added instances, increased repetition, or relocation to an alternate carrier. A control-channel monitoring schedule with a bitmap and scaling factor is broadcast and control messages are confined thereto. A guard-period descriptor with optional per-UE override is signaled. Deferred uplink is enabled by per-resource indications, buffered PDUs with expiry, and explicit grants that reference deferred identifiers.

What is claimed is:

1. A method performed by a Radio Access Network (RAN) node for managing Extended Reality (XR) sensor data transmission, the method comprising:
establishing an XR session with a UE and determining an active XR application class associated with the UE;
transmitting one or more of the sensor data dictionaries to the UE;
receiving, from the UE, uplink control information (UCI) comprising a selected dictionary identifier and a pattern row index corresponding to quantized sensor data.

2. The method of claim 1, further comprising:
re-mapping the received pattern row index to full sensor data using the associated dictionary and transmitting the re-mapped data to an XR rendering server or a core network entity over backhaul interface.

3. The method of claim 2, further comprising:
detecting uplink radio interface congestion based on resource utilization exceeding a predefined threshold over a rolling time window.

4. The method of claim 3, further comprising:
in response to detected congestion, transmitting a sensing dictionary deactivation request to the WTRU via Downlink Control Information (DCI) signaling.

5. A method performed by a User Equipment (UE) for detecting a low-power wake-up signal (LP-WUS), the method comprising:
receiving, from a radio access network node, configuration information that identifies a plurality of OFDM symbol positions that together form an LP-WUS pattern for at least one monitoring occasion;
monitoring a subset of the plurality of OFDM symbol positions that are available to the UE;
generating, for each monitored OFDM symbol position, a symbol-level detection metric indicative of LP-WUS energy or correlation on the monitored symbol;
combining the symbol-level detection metrics across the monitored subset and across at least one previous monitoring occasion to produce a fused detection score;
comparing the fused detection score to a detection threshold; and
initiating a main receiver ramp-up procedure when the fused detection score exceeds the detection threshold.

6. The method of claim 5, wherein the configuration information further specifies redundancy coding parameters for the LP-WUS pattern and wherein combining the symbol-level detection metrics comprises applying soft-combining accounting for the redundancy coding parameters.

7. The method of claim 5, further comprising receiving from the radio access network node a per-monitoring-occasion weight table and using the per-monitoring-occasion weights in computing the fused detection score.

8. The method of claim 5, further comprising aggregating authentication sub-tokens that are carried across at least two monitoring occasions prior to validating an authenticated wake event.

9. A method performed by a radio access network (RAN) node for providing service to narrowband Internet of Things devices in a time-division duplex (TDD) network, the method comprising:
determining, for a repeating frame period, which subframes are available for downlink and which subframes are available for uplink, and, where sub-band full-duplex (SBFD) is configured, which time-frequency regions within downlink symbols are downlink-valid;
determining that one or more devices are configured to expect system information (SI) or control anchors at nominal subframe locations that fall within subframes not available for downlink;
selecting alternative downlink subframe(s) within a defined SI delivery window for transmission of the system information or control anchors, and, where sub-band full-duplex (SBFD) is configured, selecting alternative downlink time-frequency region(s) within the SI window; and
broadcasting, to the devices, information identifying the selected alternative downlink subframe(s) and scheduling transmissions in accordance with the selected alternative downlink subframe(s).

10. The method of claim 9, wherein broadcasting the information comprises including a compact SI-postponement descriptor in a broadcast channel, and wherein the compact descriptor is carried in at least one of: (a) a Master Information Block (MIB), (b) a System Information Block (SIB), or (c) a newly-defined short periodic SIB dedicated to postponed anchor notifications.

11. The method of claim 10, wherein the compact SI-postponement descriptor includes, for each affected SI type, a mapping from original anchor(s) to postponed offset(s), and a continuity identifier that permits devices to detect and ignore duplicate or replayed SI transmissions.
